(19) United States
(12) Patent Application Publication
(10) Pub. No.: US 2016/0195160 A1
(43) Pub. Date: Jul. 7, 2016

(54) TORSIONAL VIBRATION DAMPER

(71) Applicant: SUEDDEUTSCHE GELENKSCHEIBENFABRIK GMBH & CO. KG, Waldkraiburg (DE)

(72) Inventors: Juergen Leinfelder, Waldkraiburg (DE); Steffen Jerye, Haag (DE); Joachim Reihle, Waldhausen (DE); Marc Brandl, Burgkirchen (DE); Armin Huber, Schoenberg (DE); Wolfgang Nindel, Muehldorf (DE); Josef Stubenrauch, Rott am Inn (DE); Bernd Scheper, Richertsheim (DE); Tanja Wainz, Taufkirchen (DE); Hüseyin Cabuk, Waldkraiburg (DE); Ralf Luedtke, Muehldorf am Inn (DE); Ruediger Kleinevoss, Neufahrn (DE)

(21) Appl. No.: 14/916,542

(22) PCT Filed: Aug. 29, 2014
(86) PCT No.: PCT/EP2014/068327

§ 371 Date: Mar. 3, 2016

(30) Foreign Application Priority Data
Sep. 4, 2013 (DE) 10 2013 014 717.4

(51) Int. Cl. F16F 15/14; F16C 3/02; F16D 3/12

(52) U.S. Cl. CPC F16F 15/1442; F16D 3/12; F16C 3/02

(57) ABSTRACT

The present invention relates to a torsional vibration damper 12 for damping vibrations of a shaft arrangement, in particular of an automotive drive train, comprising at least one first part 16, comprising a flywheel mass 18, and at least one second part 22 designed to be coaxial to the first part 16 and formed on a flange 36 for fastening the torsional vibration damper 12, wherein the first part 16 and the second part 22 are connected by means of at least elastic element 30. It is provided according to the invention that the first part 16 is provided with at least one bearing section, which is designed for radial bearing support of the first part 16 comprising the flywheel mass 18 on a bearing means 34 assigned to the flange 36.

The present invention relates to a torsional vibration damper for damping vibrations of a shaft arrangement, in particular of an automotive drive train having at least one first part, comprising the flywheel mass and at least one second part designed to be coaxial with the first part and designed for mounting the torsional vibration damper on a flange, wherein the first part and the second part are connected by at least one elastic element. Furthermore, the present in invention relates to a torque transmitting device having such a torsional vibration damper.

Torsional vibration dampers of the type defined above are known from the prior art. The document DE 43 007 583 C1 discloses a torsional vibration damper having a carrying body and a centrifugal ring connected to one another by means of six elastic elements. The segments are made of rubber and are vulcanized onto a lateral surface of the centrifugal ring and onto an outer lateral surface of the carrying body. The centrifugal ring extends radially outward around the carrying body. The carrying body serves to connect the torsional vibration damper to a flange, which in turn serves to mount the torsional vibration damper on a shaft segment of a shaft arrangement.

The document DE 44 30 036 C1 discloses a similar torsional vibration damper.

The document DE 10 2008 056 918 A1 also discloses a torsional vibration damper having an internal ring that can rotate about an axis of rotation and a mass ring coaxial with the inner ring. The mass ring extends around the inner ring on the outside at a radial distance, and the inner ring serves to connect the torsional vibration damper to a shaft arrangement and/or to a flange, which can be mounted on a shaft arrangement. A plurality of spring elements is arranged between the inner ring and the mass ring.

The torsional vibration dampers disclosed in the documents cited above have in common the fact that the mass rings and/or centrifugal rings of these dampers are supported radially on the Inner carriers and/or inner rings of these dampers by means of spring elements, so that the centrifugal rings of the known dampers tend to tumble and become unbalanced under certain circumstances. The torsional vibration dampers according to the documents cited above have been largely optimized per se with regard to their lifetime and function and have proven quite successful in practice.

However, since there tends to be less available design space in the field of automotive drive trains in particular, but the torsional vibration dampers must still meet the very high demands of the automobile industry in terms of damping vibrations in the area of the drive train, there is therefore always a demand for further improvements.

One object of the present invention is to provide a torsional vibration damper of the type defined in the introduction, which is suitable for high amplitudes and will reliably fulfill its desired function even after a long lifetime.

These objects are achieved by a torsional vibration damper having the features defined in patent claim 1.

Additional embodiments of the invention are defined in the dependent claims.

With the torsional vibration damper according to the invention, the at least one first part comprising the flywheel mass is provided with at least one bearing section. The at least one bearing section is designed for radial bearing of the first part, comprising the flywheel mass on a bearing means assigned to the flange.

The at least one bearing section is designed for radial bearing of the flywheel mass on a bearing means, which is assigned to a flange. The torsional vibration damper according to the invention is designed, so that the bearing section is supported radially and movably on the bearing means assigned to the flange. This allows a relative movement between the first part comprising the flywheel mass and the second part of the torsional vibration damper according to the invention for damping the vibration. The amount of relative movement between the first part comprising the flywheel mass and the second part designed for mounting the torsional vibration damper on the flange is determined by the at least one elastic element, which serves to connect the first part and the second part.

Due to the radial bearing of the first part with the flywheel mass, the torsional vibration damper according to the invention is very stiff radially. Due to the high radial stiffness of the torsional vibration damper according to the invention, the behavior of the damper is greatly improved in the event of an imbalance in the drive train. Furthermore, the flywheel mass has a much lower tendency to tumbling movements because of the radial bearing over its bearing section on the bearing means assigned to the flange, so that the torsional vibration damper can reliably fulfill its desired function, i.e., reliably damping vibrations in a predetermined frequency range. The torsional vibration damper according to the invention exhibits a greatly improved behavior when there is an imbalance, so the at least one spring element is under less load, and the lifetime of the torsional vibration damper is increased.

The bearing means assigned to the flange may be, for example, a section of the flange for a centering sleeve connected to the flange.

The natural frequency of the torsional vibration damper is determined by the stiffness of the at least one elastic element and the moment of inertia of the flywheel mass and counteracts the torsional vibrations of the drive shaft of an automotive drive train, for example. The elastic element can be made of an elastomer, a thermoplastic elastomer or a silicone.

The axial guidance of the first part and of the flywheel mass can be accomplished by means of the at least one elastic element. However, according to the invention, it is also possible for a form-fitting connection to be established between the first part and the second part according to a predetermined deflection in the axial direction, so that the axial deflections can be limited in this way. Furthermore, the axial stops, for example, in the form of protruding lugs, may be arranged or formed on the first part and/or the second part.

The at least one elastic element of the torsional vibration damper according to the invention may be designed to be much larger in the radial direction. The risk of imbalance of the flywheel mass is not increased by this measure because the first part comprising the flywheel mass is supported radially over the bearing section on a bearing means assigned to the flange. Due to an elastic element, which becomes larger in the radial direction, the stress distribution in the elastic element is improved in the case of a load, which also contributes to the lifetime of the torsional vibration damper.

According to one specific embodiment, the bearing section of the first part may be designed so that the bearing section slides on the bearing means assigned to the flange when there is a relative movement between the first part and the second part. As already mentioned, when the torsional vibration damper is arranged in an automotive drive train, for example, a relative movement between the first part, which comprises, the flywheel mass and the second part, which is connected to a flange of the automotive drive train, takes place during operation of the automotive drive train. The second part moves with the drive train. Due to the moment of inertia of the flywheel mass, the flywheel mass and/or the first part moves with a delay in comparison with the second part, so that the at least one elastic element can be exposed to tensile stress, compressive stress or shearing stress. Since the second part of the torsional vibration damper rotates with the drive train, the bearing section slides on the bearing means assigned to the flange.

In this context, the bearing section may comprise at least one bearing element. The at least one bearing element may be arranged on a radial inside surface of the bearing section. The at least one bearing element may be a friction bearing. Furthermore, the at least one bearing element may be a bearing bush or a coated friction bearing, for example. If a bearing bush is used as the bearing element, this bearing bush may be made of plastic, for example. The at least one bearing element may be connected to the first part and in particular to the bearing section of the first part. For example, the bearing element may be pressed into the bearing section.

The at least one elastic element may be provided on a radial outside surface of the at least one bearing section. In this case, the second part of the torsional vibration damper, which is designed for mounting on a flange, may extend on the outside radially around the bearing section of the first part.

The second part may have at least one receiving section. The at least one receiving section can accommodate the at least one bearing section of the first part in at least some sections. Then the receiving section and the bearing section may be connected by the at least one elastic element. The second part may extend with at least one receiving section on the outside radially around the bearing section of the first part at a predetermined radial distance around it.

The bearing section of the first part and the receiving section of the second part may be tubular in design. Between the bearing section of the first part and the receiving section of the second part, a predetermined radial distance may be provided in which the at least one elastic element is arranged.

The at least one elastic element may be attached to the receiving section and/or to the bearing section. However, it is also conceivable for the at least one elastic element to be pressed between the bearing section and the receiving section.

Alternatively, the bearing section may have at least one protrusion, which can engage in at least corresponding recess on the receiving section. The at least one elastic element may be arranged between the at least one protrusion and the at least one recess. The at least one elastic element may be provided between the at least one protrusion on the bearing section and the at least recess on the receiving section, so that the at least elastic element is mainly under compressive load. It is possible according to the invention for the at least one elastic element to extend between side surfaces of the protrusions of the bearing section extending essentially in the radial direction and the recesses in the receiving section and therefore to be subject exclusively to compressive load during operation.

The first part and the second part may have a corresponding profiling, which serves to adjust a maximum relative angle between the first part and the second part. In this context, the relative angle is understood to be the angle around the central axis of the torsional vibration damper, which occurs with a relative movement between the first part and the second part. The maximum relative angle also corresponds to the maximum amplitude of the first part comprising the flywheel mass. An overload on the at least one elastic element is prevented by an adjustment of the maximum relative angle and/or the maximum amplitude. The profiling on the first part and/or on the second part can be covered with an elastic layer.

The first part, comprising the flywheel mass, may have at least one opening. The at least one opening in the first part can allow a torque transmitting connection of the second part to the flange. The first part may be designed so that a relative movement is possible between the first part and the second part. The second part may be accommodated in the first part between the bearing section and the flywheel mass. However, since the first part is designed for connection to a flange, the connection between the flange and the second part must be established through the at least one opening in the first bearing part.

The first part may be designed so that the flywheel mass extends around the bearing section at a predetermined radial distance.

The first part and/or the second part may be made of steel, aluminum or plastic, for example. If the first part is made of plastic or a material having similar frictional properties, then the first part which is manufactured from such a material may also serve directly as the bearing element. It is therefore possible to omit a separate bearing bush.

The first part and/or the second part may be designed with beads and/or ribs for reinforcement.

According to one embodiment of the invention, at least one sealing element may be provided. The at least one sealing element may be a sealing lip, which extends radix ally inward. For example, the at least one sealing element may be designed in one piece with the at least one elastic element. Furthermore, the at least one sealing element may be designed so that the sealing element spans the at least one bearing element. The at least one sealing element may also be designed on an elastic layer connecting the at least one bearing section to the at least one bearing element.

The at least one bearing element may have at least one recess. The at least one recess may preferably be provided on the inside circumferential surface of the at least one bearing element. The at least one recess may extend in the axial direction along the inside circumferential surface of the at least one bearing element.

The first part of the vibration damper may be designed as a modular unit. The bearing section may form a modular unit. The bearing section may form a modular unit together with the at least one elastic element. Furthermore, the at least one bearing section may form a unit with the at least one bearing element. To do so, the at least one bearing section may be connected to the at least one bearing element by means of an elastic layer. The modular unit may also be formed by the at least one bearing section, the at least one elastic element and the at least one bearing element. An additional modular unit of the first part is formed by the section of the first part which supports the flywheel mass. The modular unit with the at least one bearing section and the modular unit for supporting the flywheel mass may be connected to one another by means of various joining methods. For example, the two units can be joined to one another by a welding method. The modular design of the first part offers the advantage that it is not necessary to perform any other steps on the first part after connecting the modular units.

The at least one flywheel mass can be connected to the first part by means of a form-fitting connection.

According to one embodiment, the first part and the second part may be designed so that the at least one elastic element runs at an angle to the central axis of the torsional vibration damper in at least some sections.

The first part may have a section extending in the radial direction. Similarly, the second part may have a section extending in the radial direction. The at least one elastic element may extend between the radial sections of the first part and of the second part.

The second part may be arranged on the side of the first part facing away from the bearing section. Alternatively, it may also be arranged on the side facing the bearing section.

The present invention also relates to a torque transmitting device for transmitting torques between two shaft sections of a shaft arrangement, in particular an automotive drive train. The torque transmitting device comprises a torsional vibration damper having the features described above and an elastic articulated body. The elastic articulated body is connected to the second part of the torsional vibration damper and is arranged between the flywheel mass and the second part of the torsional vibration damper.

Due to the high radial stiffness of the torsional vibration damper and/or due to the radial bearing of the first part with the flywheel mass on a bearing means assigned to the flange, the first bearing part with the flywheel mass may serve as a centrifugal force safety device for the elastic articulated body. This prevents destruction of the articulated body due to centrifugal forces at high and very high rotational speed of the shaft arrangement, for example, of an automotive drive train. At the same time the elastic articulated body may serve as overload protection for the at least one elastic element of the torsional vibration damper at rotational speeds. At high rotational speeds the elastic articulated body bulges in the radial direction. Due to the bulging elastic articulated body, torsional movements of the flywheel mass and/or of the first part at high rotational speeds are blocked. Even in this case, an increased imbalance can be prevented by the radial bearing of the flywheel mass on a bearing means assigned to the flange and/or due to the high radial stiffness of the torsional vibration damper thereby achieved.

A predetermined radial gap may be provided between the elastic articulated body and a section of the first part extending around the articulated body in the circumferential direction. The predetermined radial gap may be of such dimensions that the elastic articulated body is in contact with the sectional of the first part extending around the articulated body during operation of the torque transmitting device after exceeding a predetermined rotational speed or a predetermined torque. The size of the gap may be in the millimeter range, for example. The gap may be less than or equal to 4 mm, for example, in the range of 3 mm. However, the gap may also be less than or equal to 2 mm.

The torque transmitting device may include a flange. The flange may be connected to the second part of the torsional vibration damper and the elastic articulated body in a torque transmitting connection. In this context, the flange may transmit the torque by means of at least one opening in the first part with the second part and the elastic articulated body. In other words, an arm of the flange, for example, may extend into the at least one opening in the first part in at least some sections and/or may overlap with this opening and come in contact with the second part there in order to be able to connect the second part and the elastic articulated body to the flange in a torque transmitting manner. A second part may be bolted or pressed onto the flange, for example.

The flange can accommodate a centering sleeve in at least some sections. In this case, the centering sleeve may be designed as a bearing means assigned to the flange. The first part of the torsional vibration damper comprising the flywheel mass may thus be supported radially with its bearing section on the centering sleeve. In other words, the bearing section of the first part can accommodate the centering sleeve in at least some sections and can execute a relative movement for vibration damping on the centering sleeve and/or slide on the centering sleeve with a relative movement. In this context, the torsional vibration damper may be supported radially on the centering sleeve by means of the bearing section of the second part.

Alternatively, the torsional vibration damper may be supported radially on the flange by means of the bearing section of the second part. In this case the flange has a section which serves as the bearing means assigned to the flange.

The bearing section of the first part may also be supported radially on a section of the flange, which serves as the bearing means and at the same time be supported radially on a section of a centering sleeve. A bearing element may be provided in the section in which the bearing section is supported on the centering sleeve.

According to one specific embodiment of the invention, the at least one elastic articulated body may have a polygonal shape wherein the predetermined radial gap changes in the circumferential direction.

Due to the polygonal shape of the at least one elastic articulated body, it is almost impossible for the at least one articulated body to be stopped on the first part and/or the flywheel mass of the torsional vibration damper.

The present invention also relates to a shaft arrangement, in particular on automotive drive train having a torsional vibration damper with the features described above or a torque transmitting device according to type described above.

Exemplary specific embodiments of the invention are described below on the basis of the accompanying figures, in which;

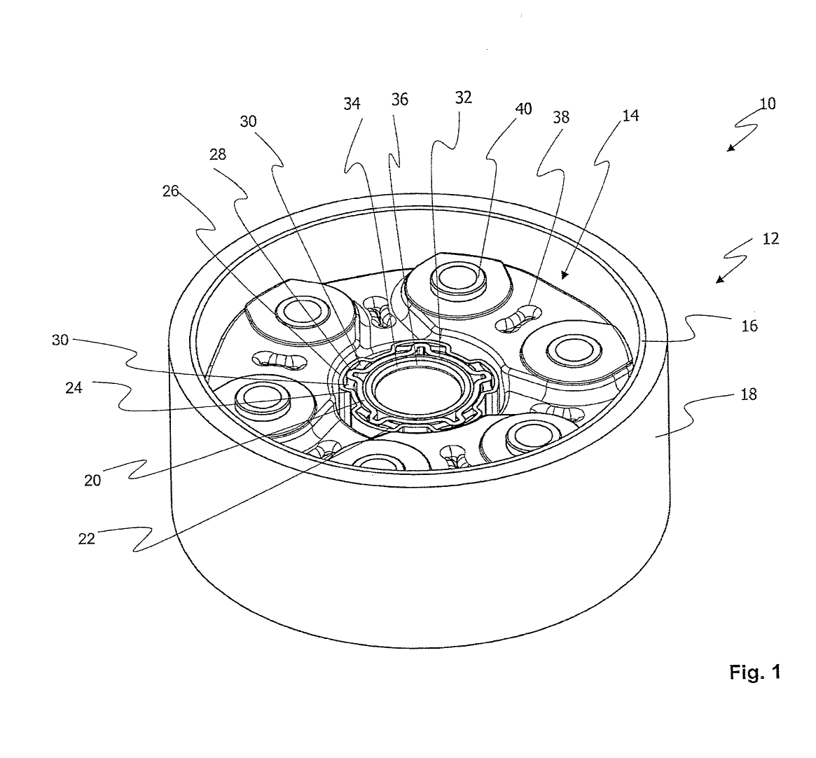

FIG. 1 shows a perspective view of a torque transmitting device according to a first specific embodiment of the invention;

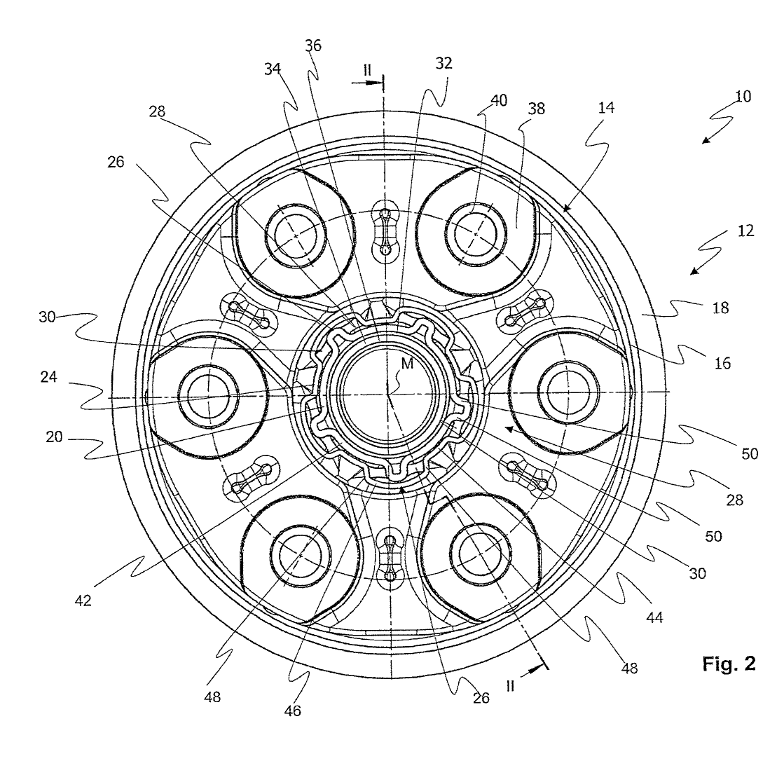

FIG. 2 shows a top view of the torque transmitting device according to FIG. 1;

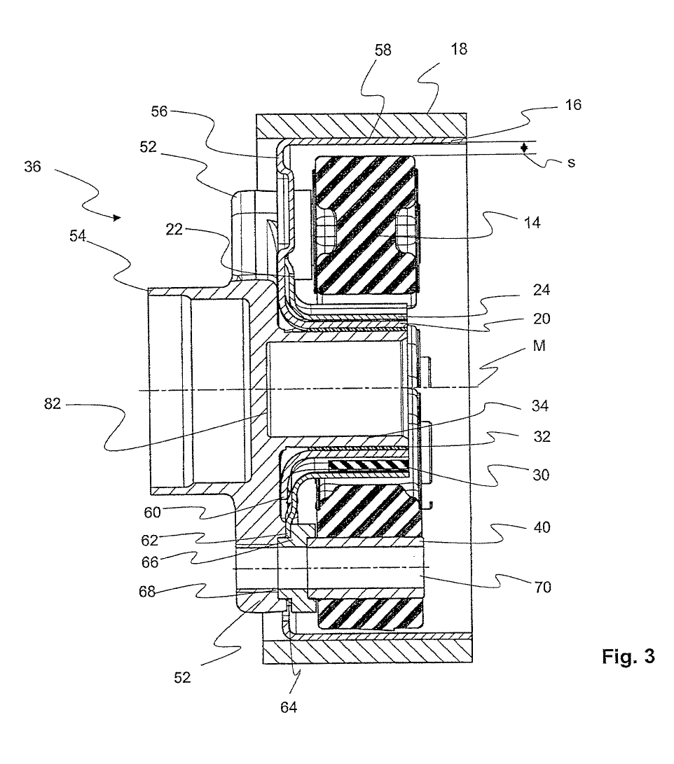

FIG. 3 shows a sectional view of the torque transmitting device according to the first specific embodiment of the invention along the sectional line II-II in FIG. 2;

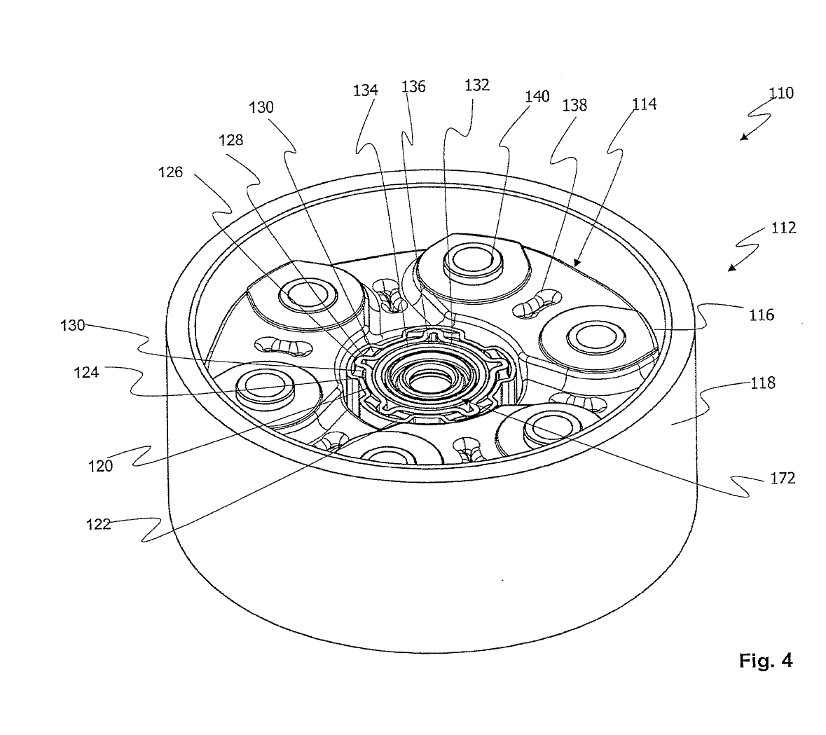

FIG. 4 shows a perspective view of a torque transmitting device according to a second embodiment of the invention;

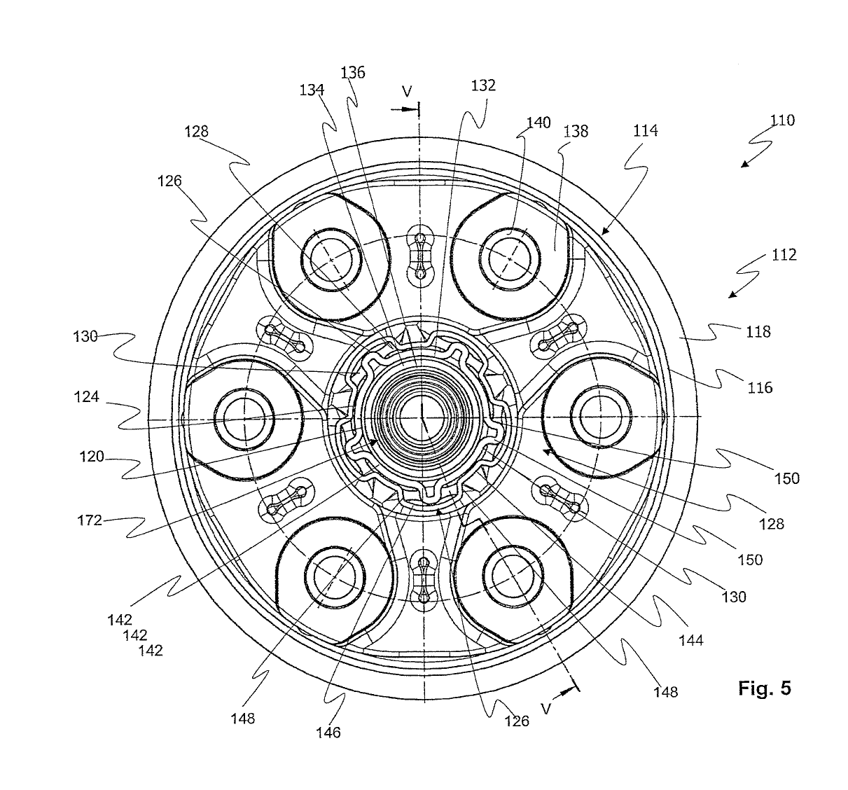

FIG. 5 shows a top view of the torque transmitting device according to FIG. 4;

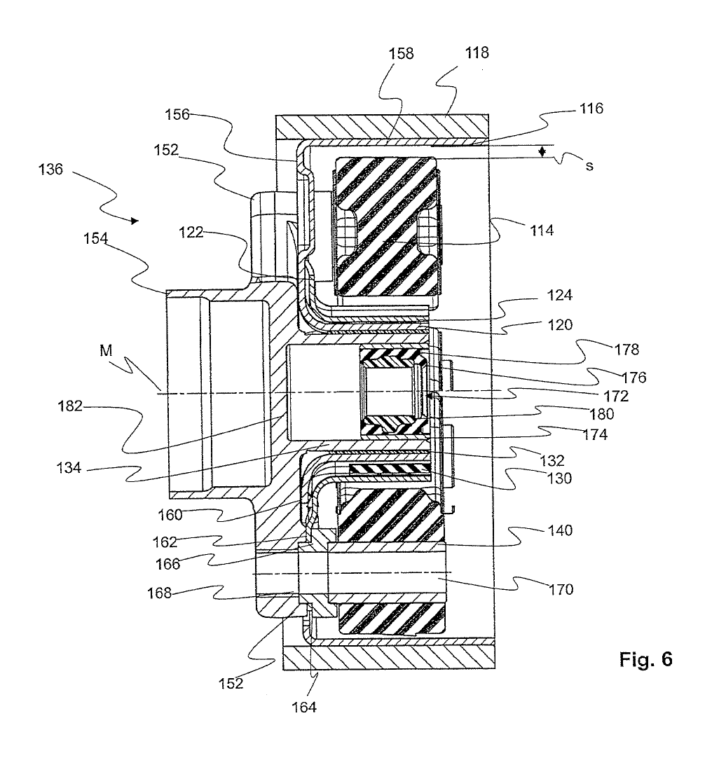

FIG. 6 shows a sectional view of the torque transmitting device according to the second embodiment of the invention along the sectional line V-V in FIG. 5;

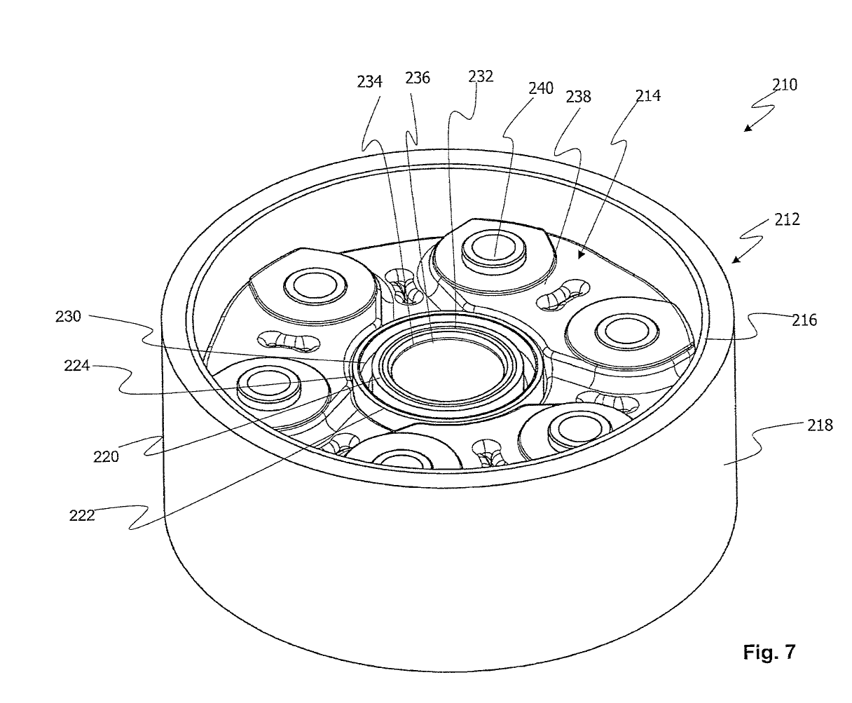

FIG. 7 shows a perspective view of a torque transmitting device according to a third embodiment of the invention;

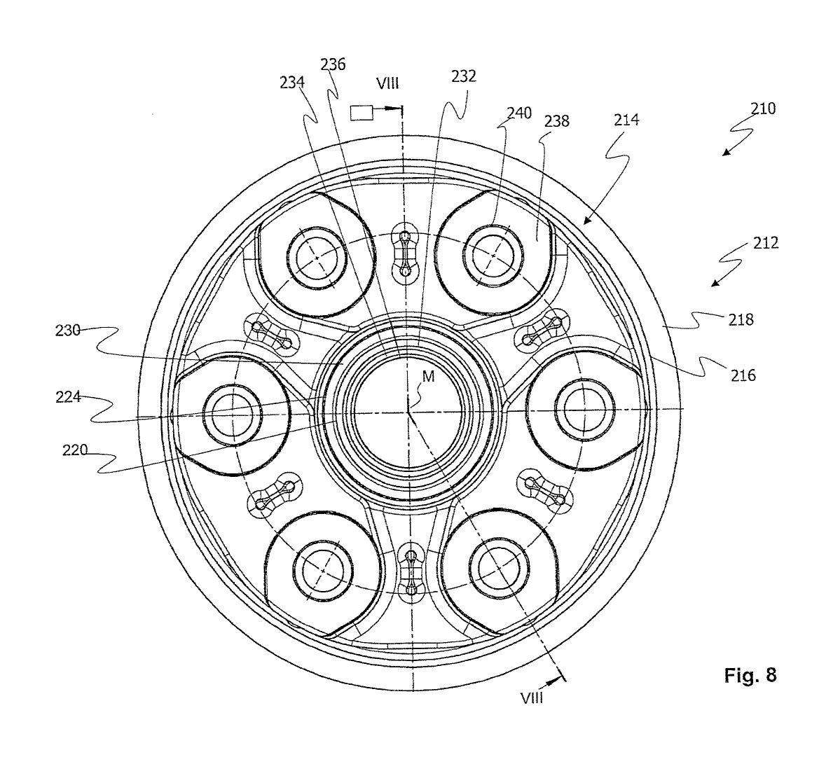

FIG. 8 shows a top view of the torque transmitting device according to FIG. 7;

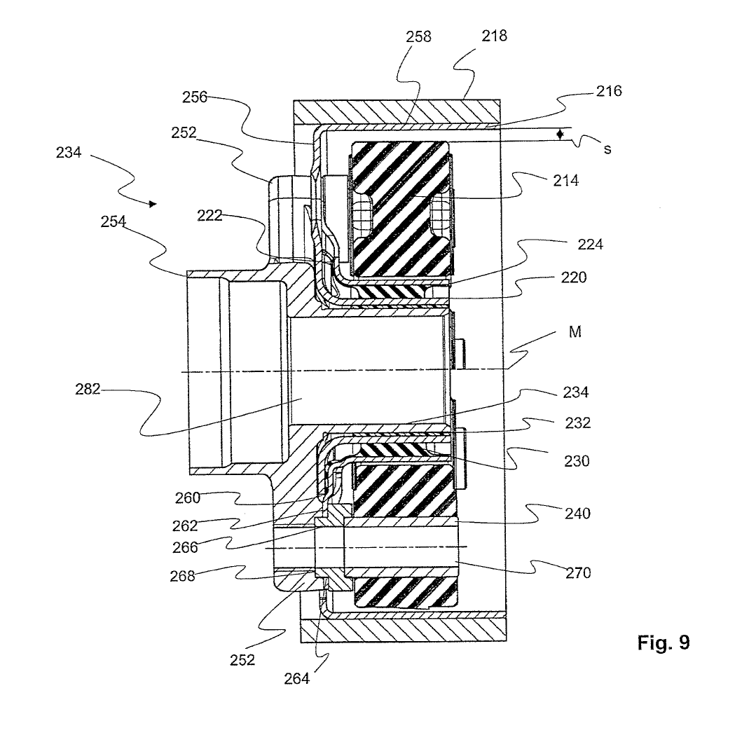

FIG. 9 shows a sectional view of the torque transmitting device according to the third embodiment of the invention along the sectional line VIII-VIII in FIG. 8;

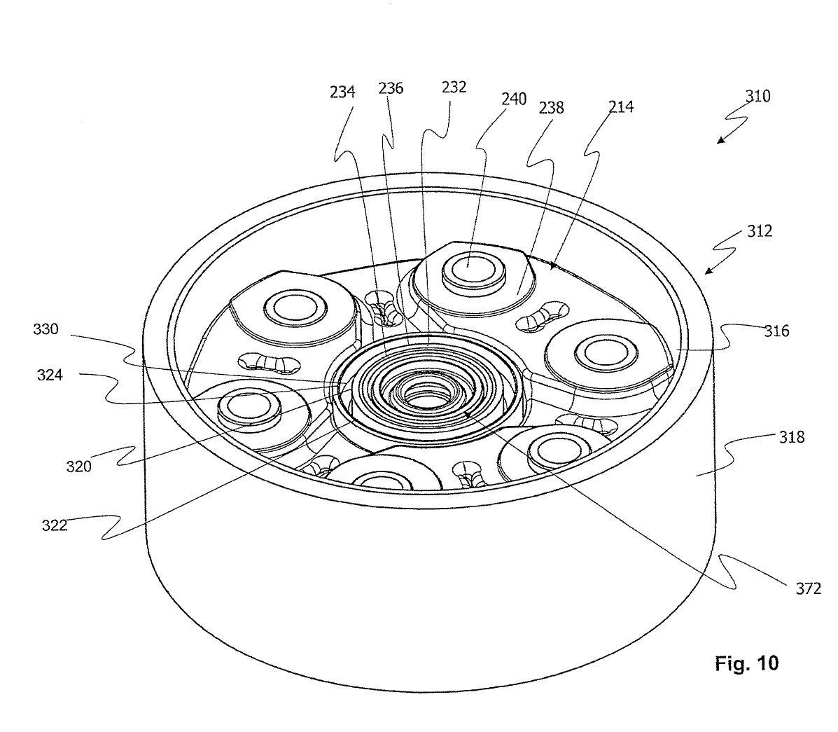

FIG. 10 shows a perspective view of a torque transmitting device according to a fourth embodiment of the invention;

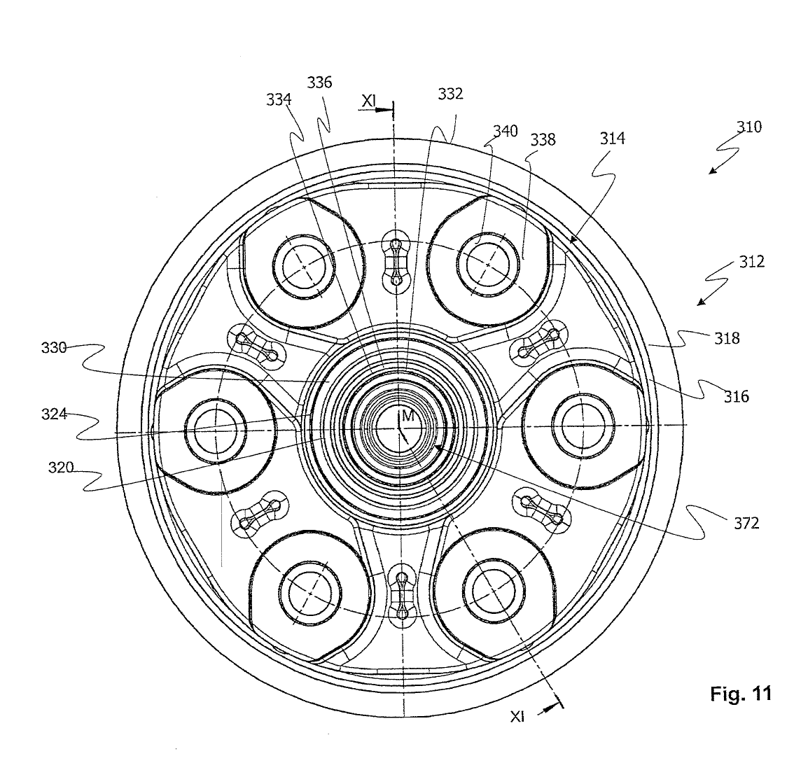

FIG. 11 shows a top view of the torque transmitting device according to FIG. 10;

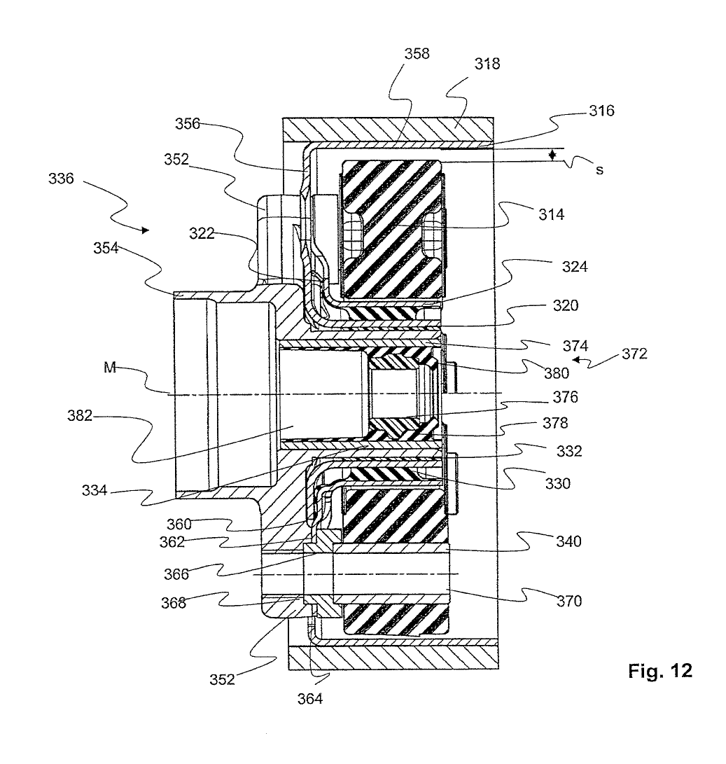

FIG. 12 shows a sectional view of the torque transmitting device according to the fourth embodiment along the sectional line XI-XI in FIG. 11;

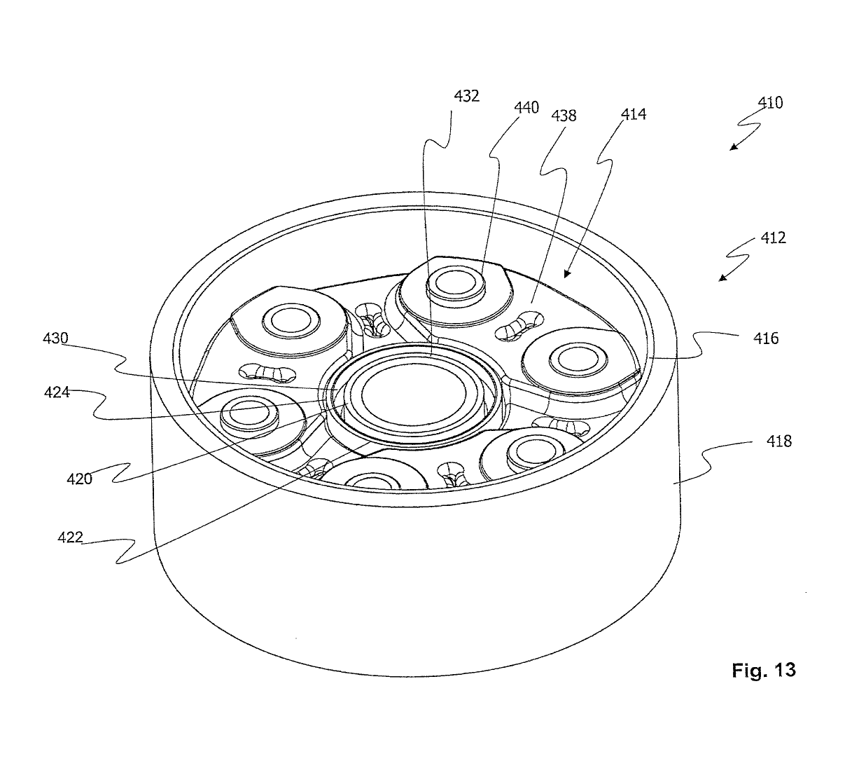

FIG. 13 shows a perspective view of a torque transmitting device according to a fifth embodiment of the invention;

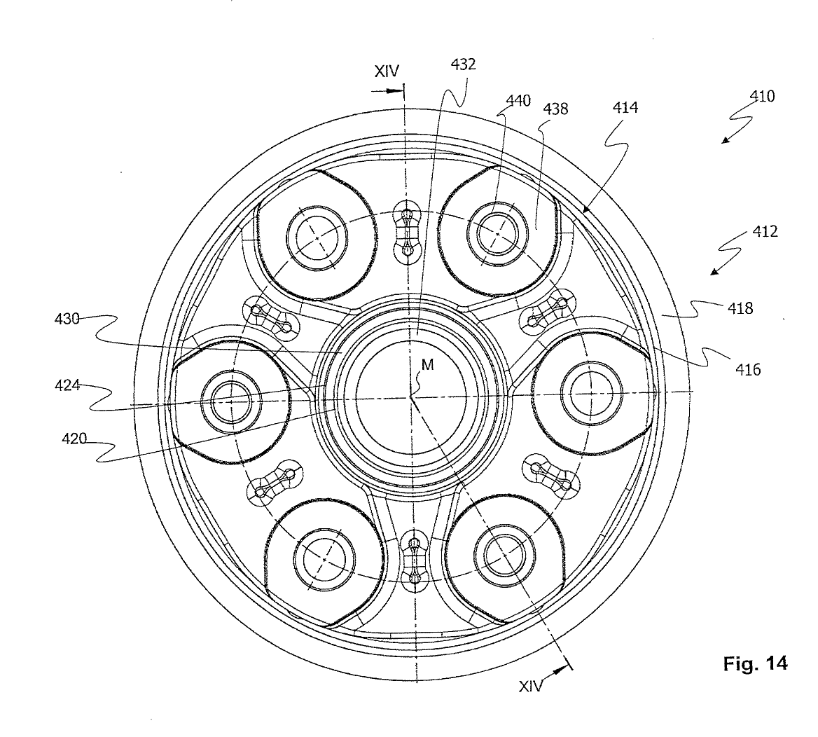

FIG. 14 shows a top view of the torque transmitting device according to FIG. 13;

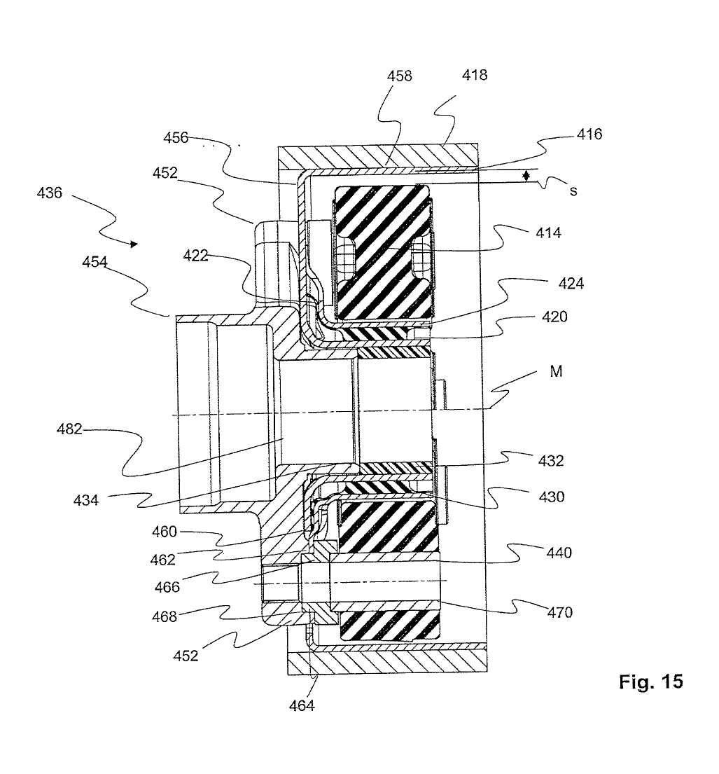

FIG. 15 shows a sectional view of the torque transmitting device according to the fifth embodiment of the invention along the sectional line XIV-XIV in FIG. 14;

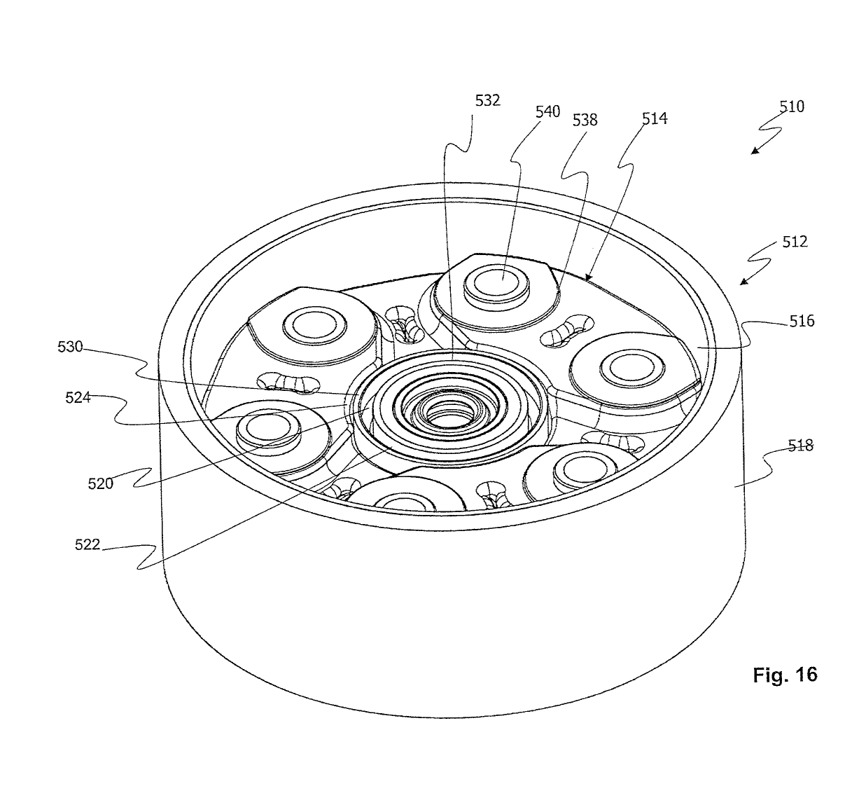

FIG. 16 shows a perspective view of a torque transmitting device according to a sixth embodiment of the invention;

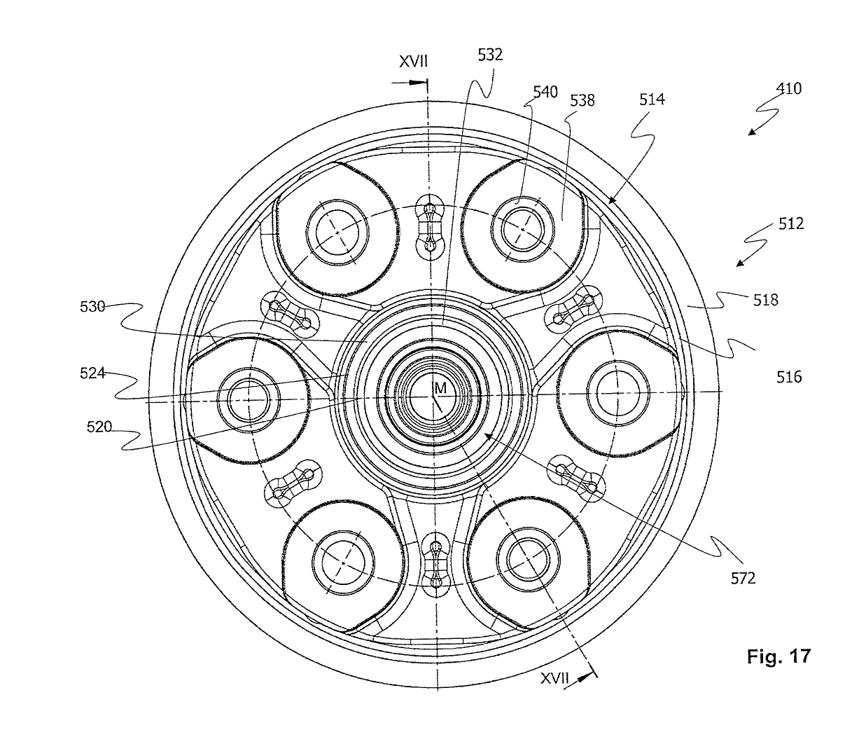

FIG. 17 shows a top view of the torque transmitting device according to FIG. 16;

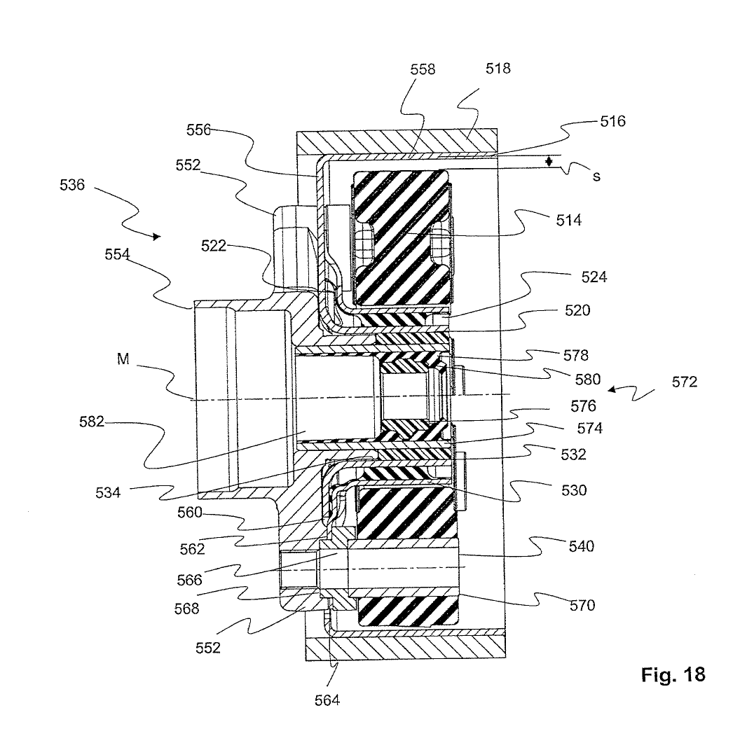

FIG. 18 shows a sectional view of the torque transmitting device according to the sixth embodiment along the sectional line XVII-XVII in FIG. 17;

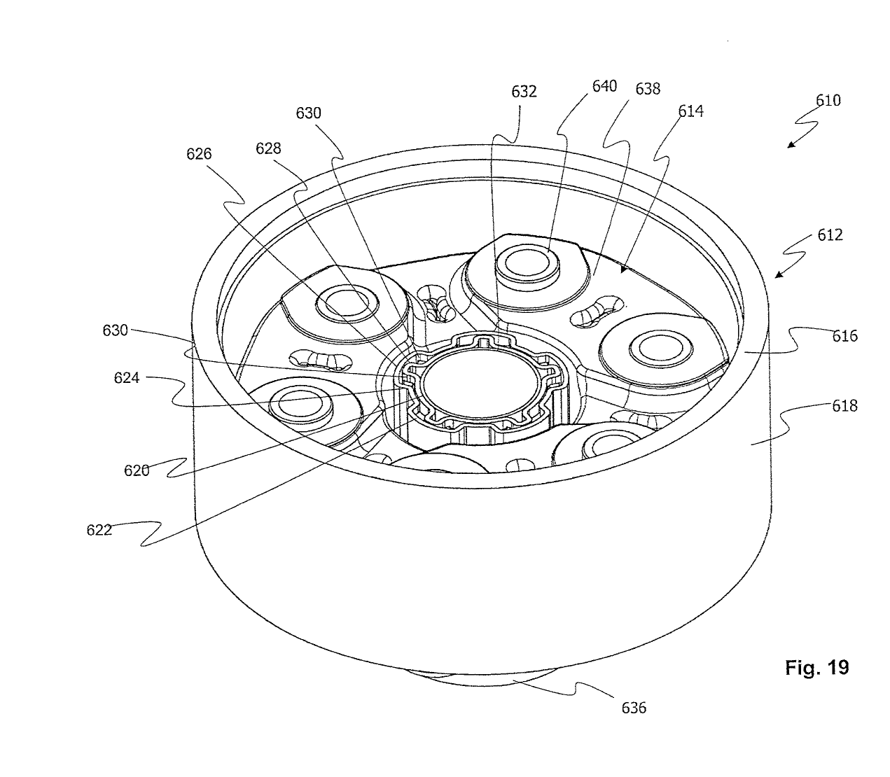

FIG. 19 shows a perspective view of a torque transmitting device according to a seventh embodiment of the invention;

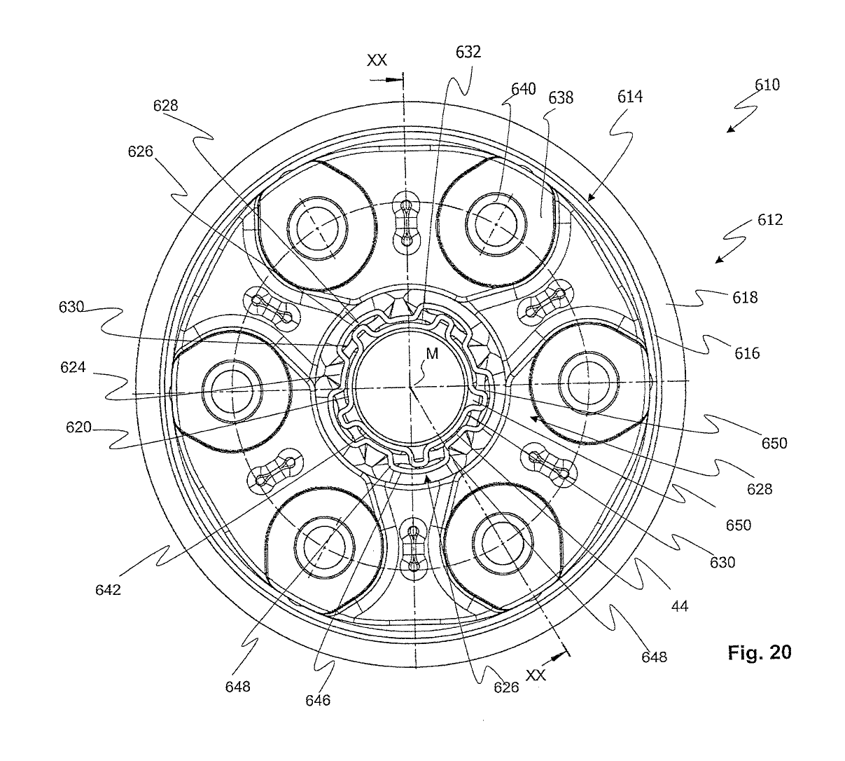

FIG. 20 shows a top view of the torque transmitting device according to FIG. 19;

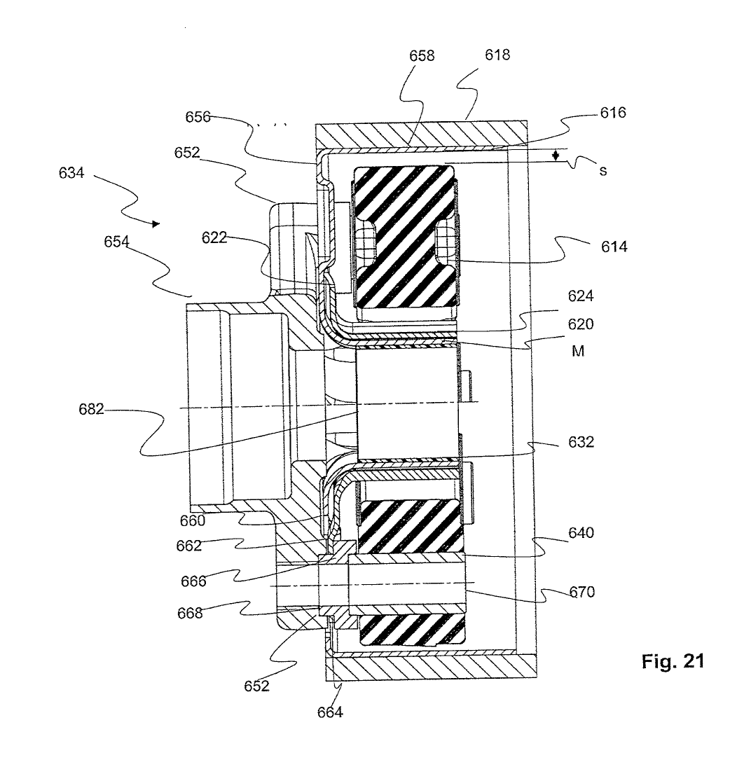

FIG. 21 shows a sectional view of the torque transmitting device according to the seventh embodiment of the invention along the sectional line XX-XX in FIG. 20;

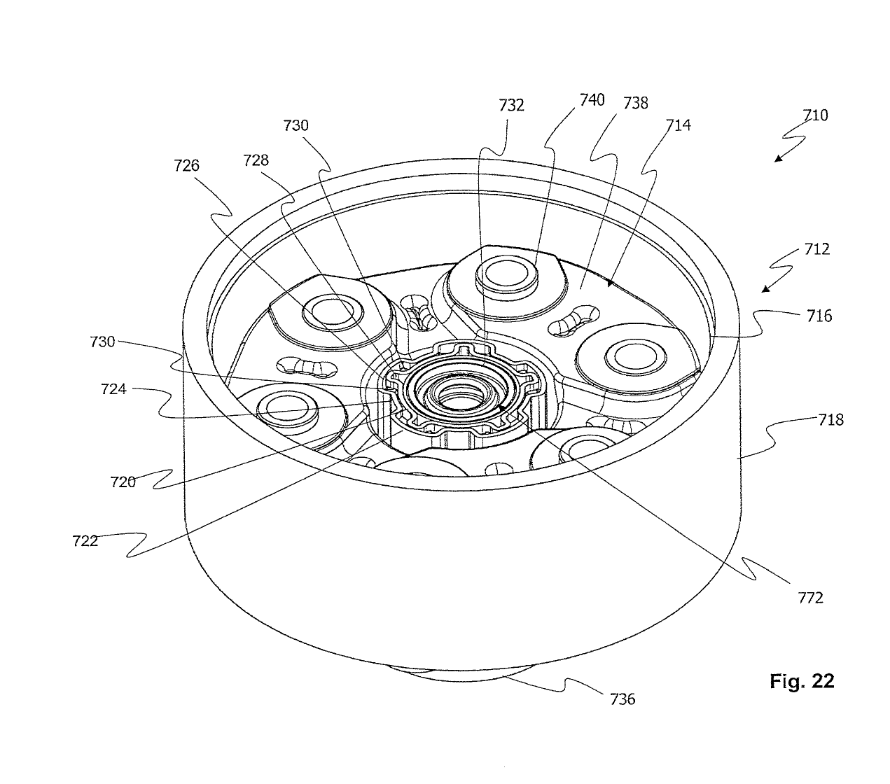

FIG. 22 shows a perspective view of a torque transmitting device according to the eighth embodiment of the invention;

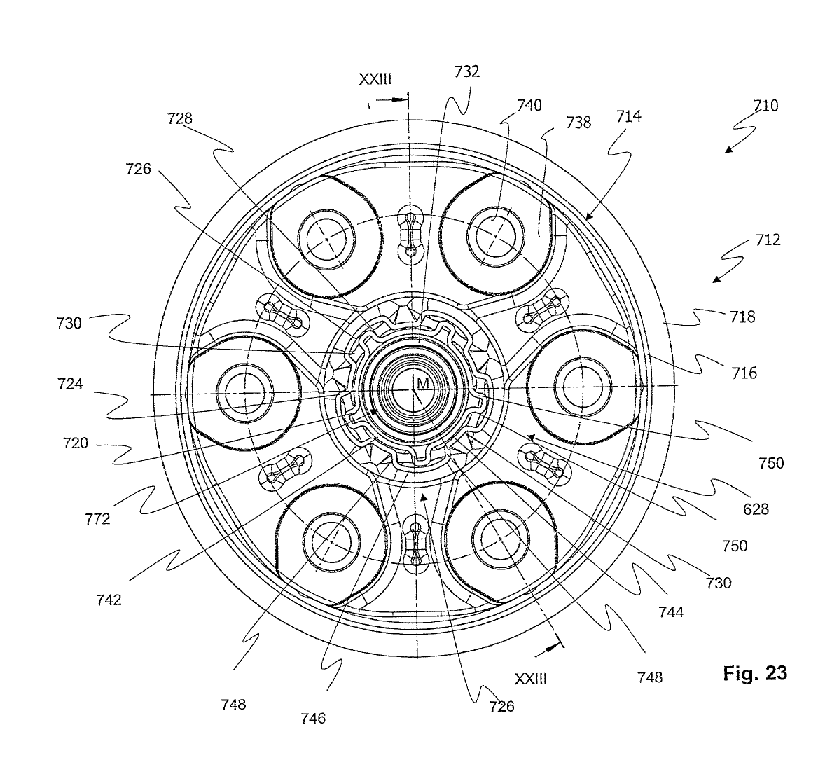

FIG. 23 shows a top view of the torque transmitting device according to FIG. 22;

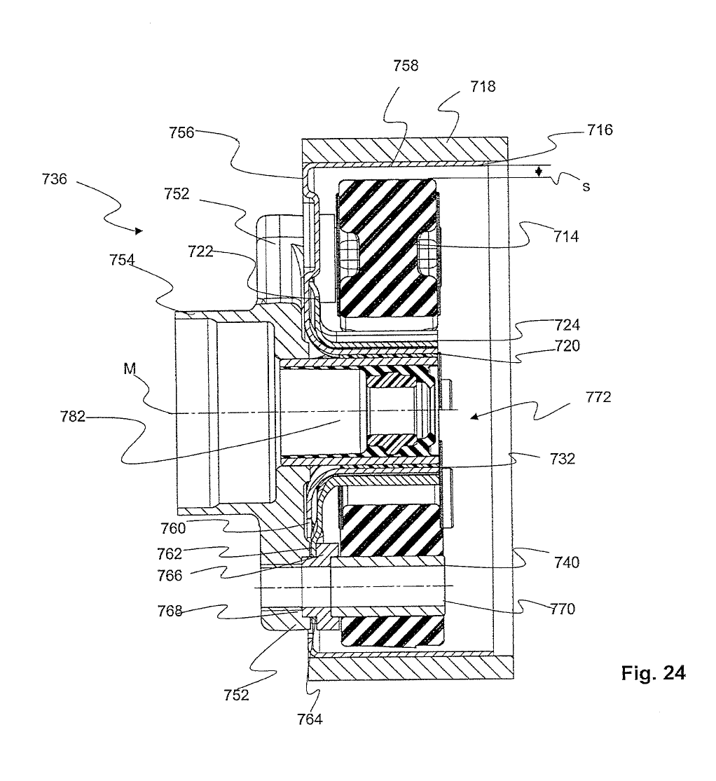

FIG. 24 shows a sectional view of the torque transmitting device according to the eighth embodiment of the invention along the sectional line XXIII-XXIII in FIG. 23;

FIG. 25 a top view of a first part of a torsional vibration damper according to one exemplary embodiment of the invention;

FIG. 26 a detailed view of the detail X in FIG. 25;

FIG. 27 a sectional view along sectional line XXVI-XXVI in FIG. 26;

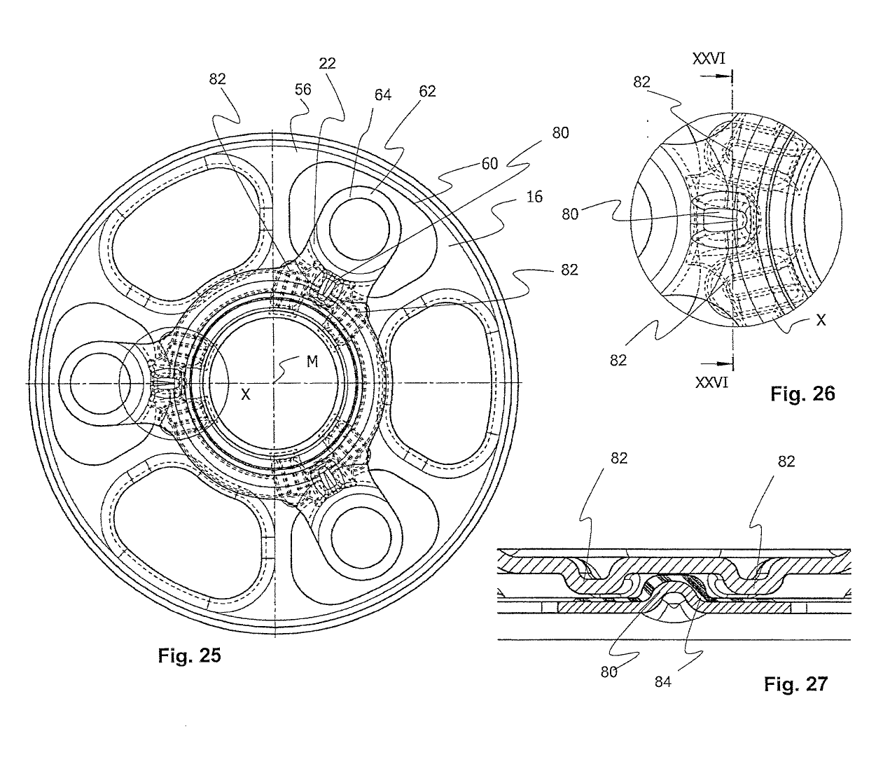

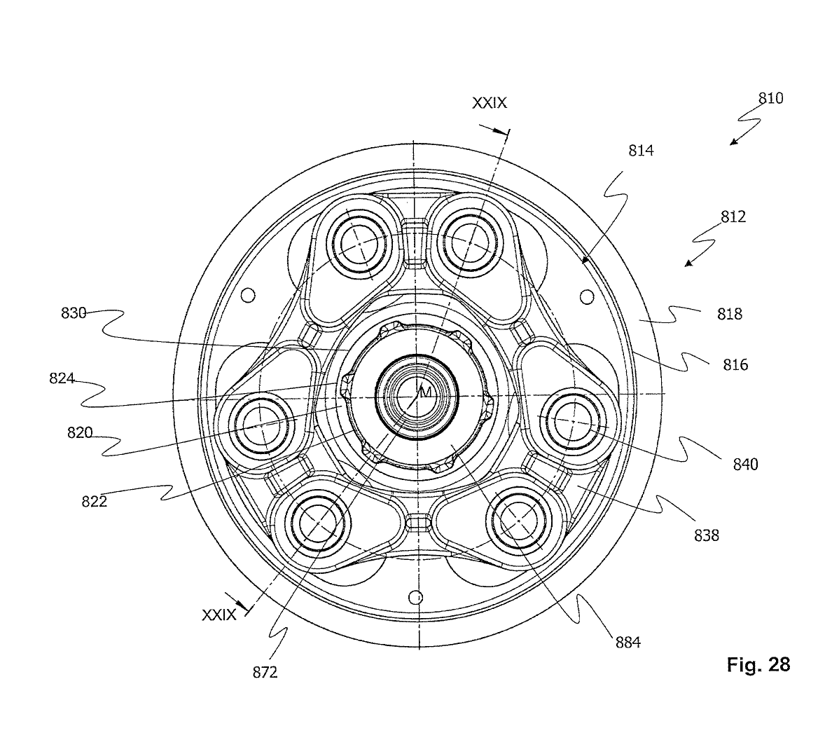

FIG. 28 a top view of a torque transmitting device according to a ninth specific embodiment;

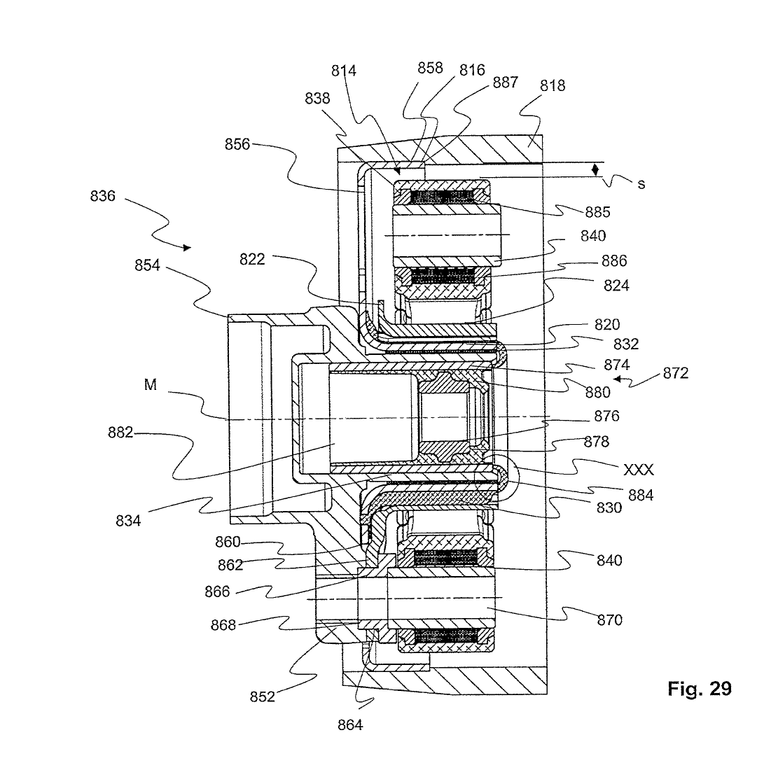

FIG. 29 a sectional view along sectional line XXIX-XXIX in FIG. 28;

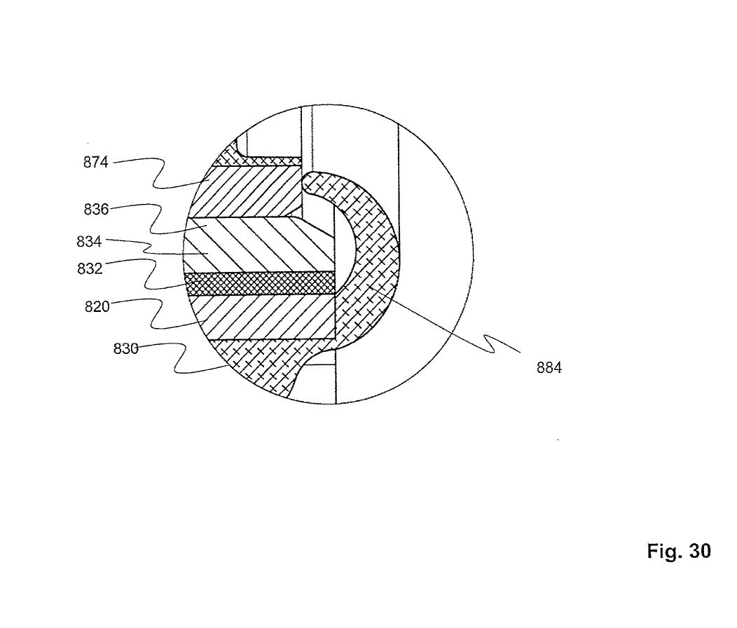

FIG. 30 a detailed view of the detail XXX in FIG. 28;

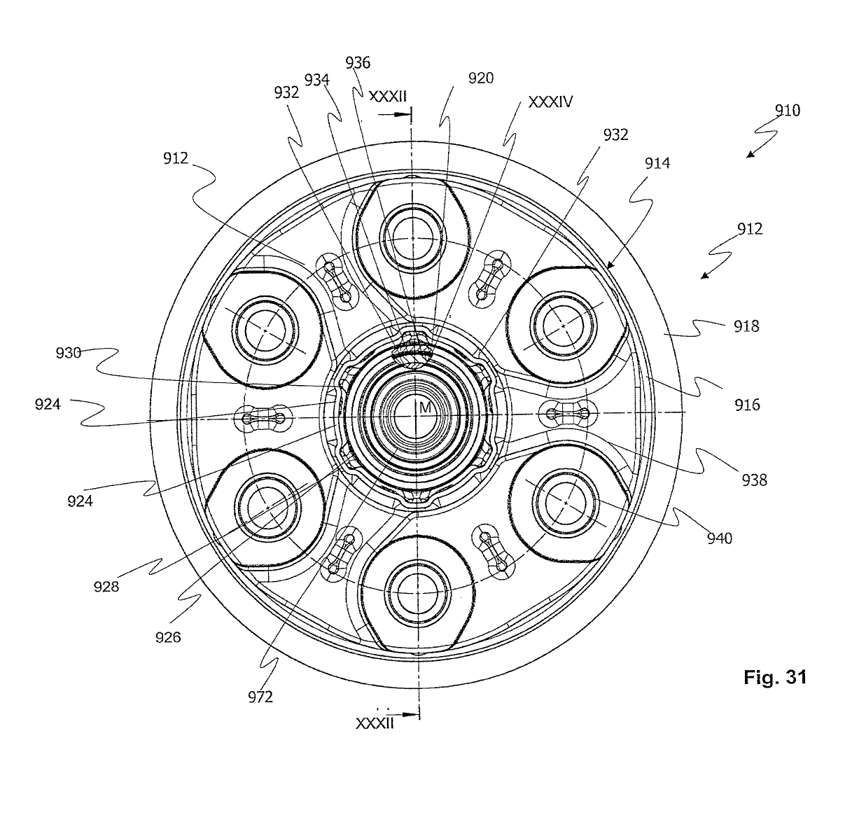

FIG. 31 a top view of a torque transmitting device according to a tenth specific embodiment of the Invention;

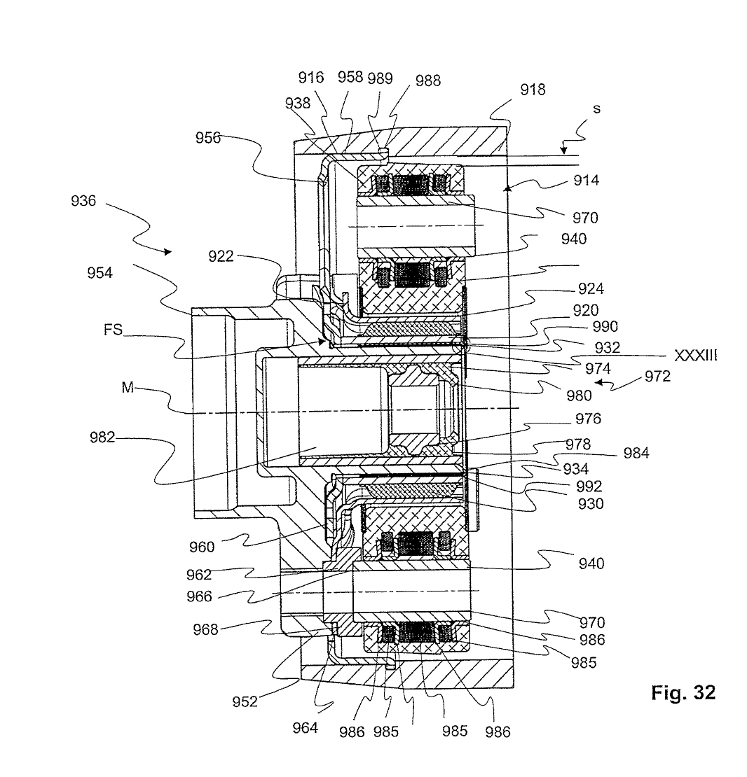

FIG. 32 a sectional view along sectional line XXXII-XXXII in FIG. 31;

FIG. 33 a detailed view of the detail XXXIII in FIG. 32;

FIG. 34 a detailed view of the detail XXXIV in FIG. 31;

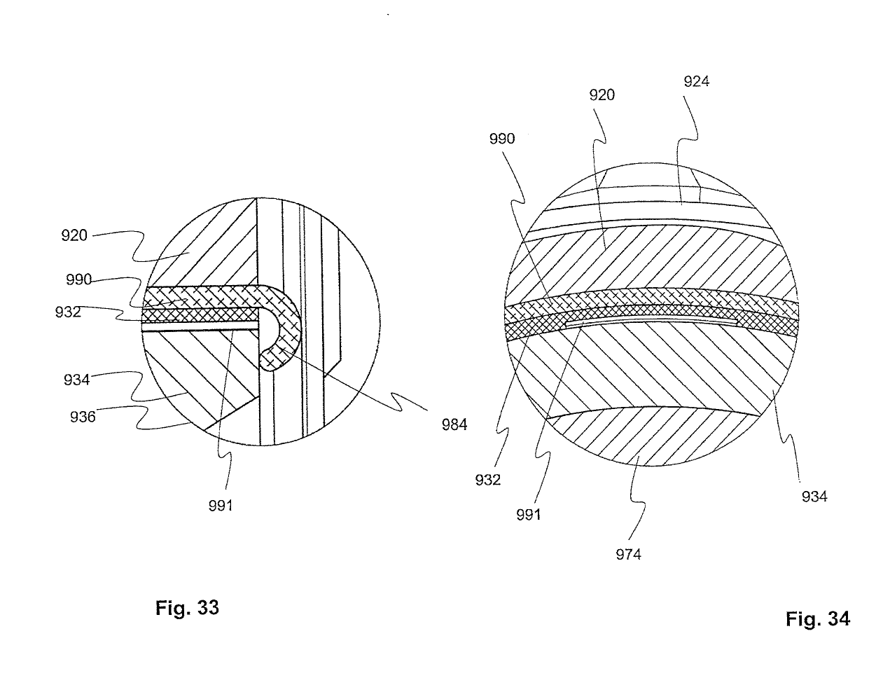

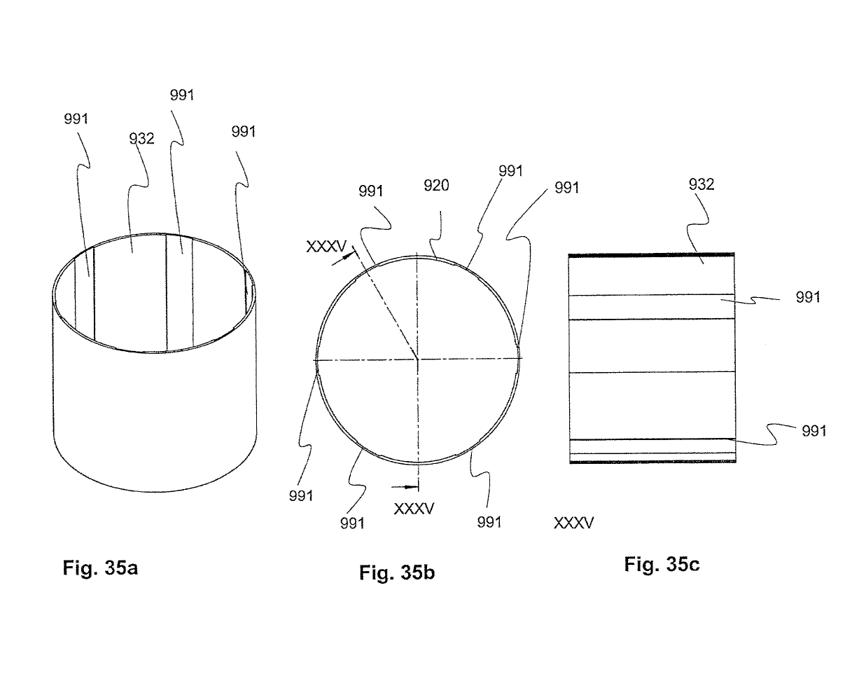

FIG. 35a-35c views of a bearing element;

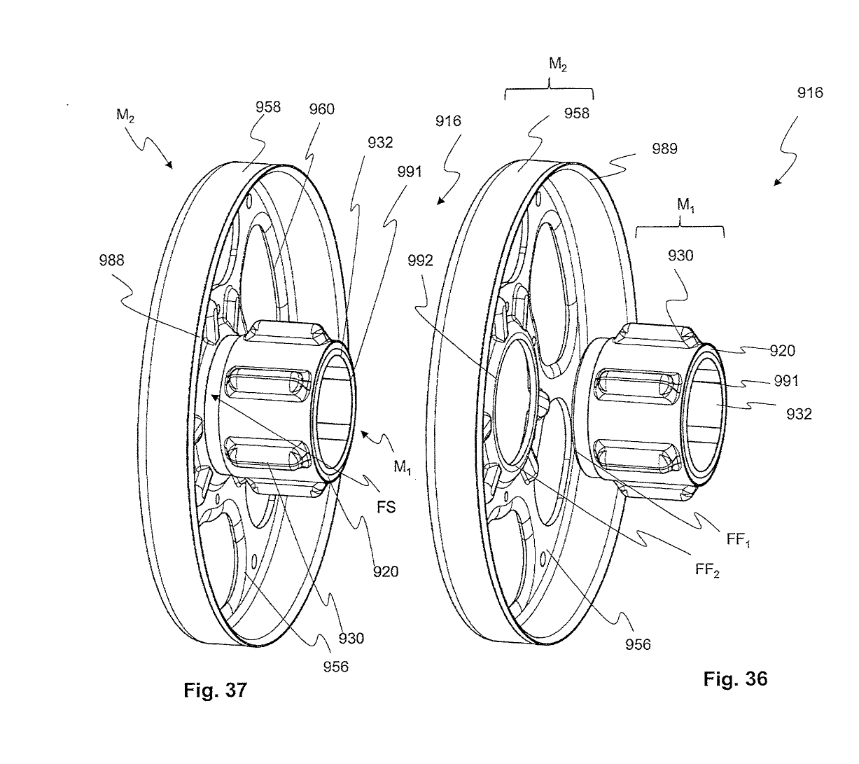

FIG. 36 a perspective view of the first part of the torsional vibration damper in the separated state;

FIG. 37 a perspective view of the first part of the torsional vibration damper in the connected section;

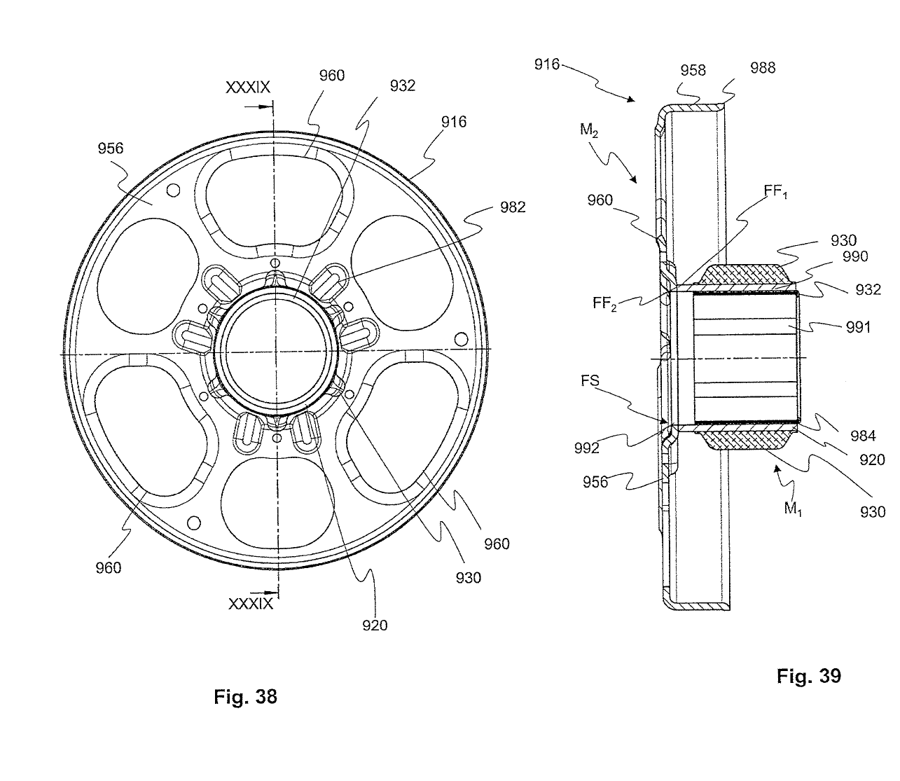

FIG. 38 a top view of the first part of the torsional vibration damper;

FIG. 39 a sectional view along sectional line XXXIX-XXXIX in FIG. 38;

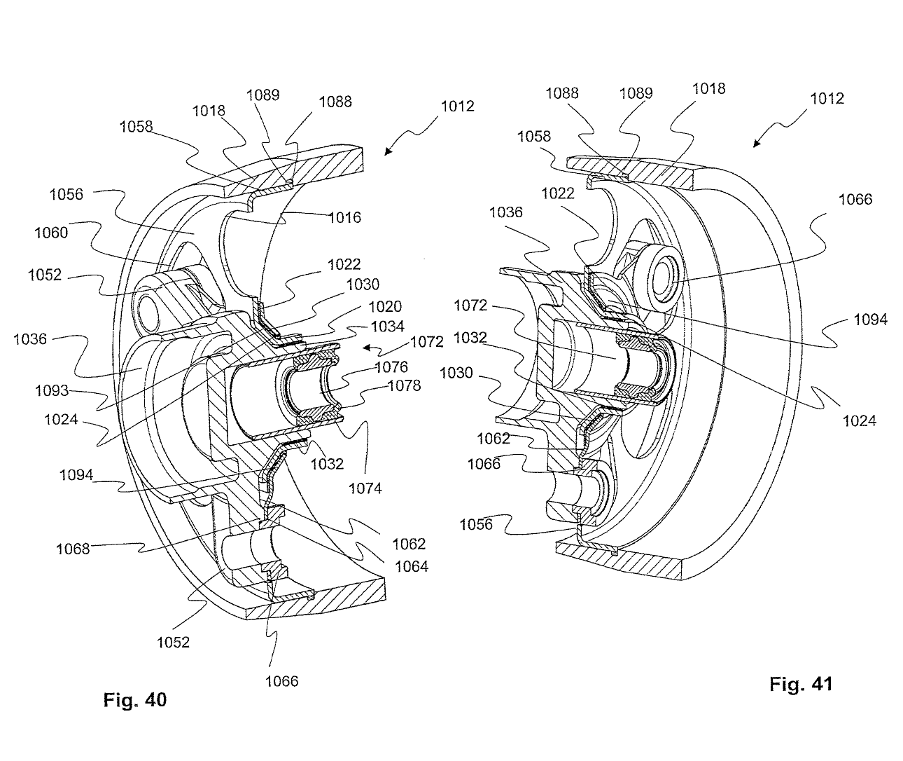

FIGS. 40 and 41 perspective sectional views of a torsional vibration damper according to an eleventh embodiment;

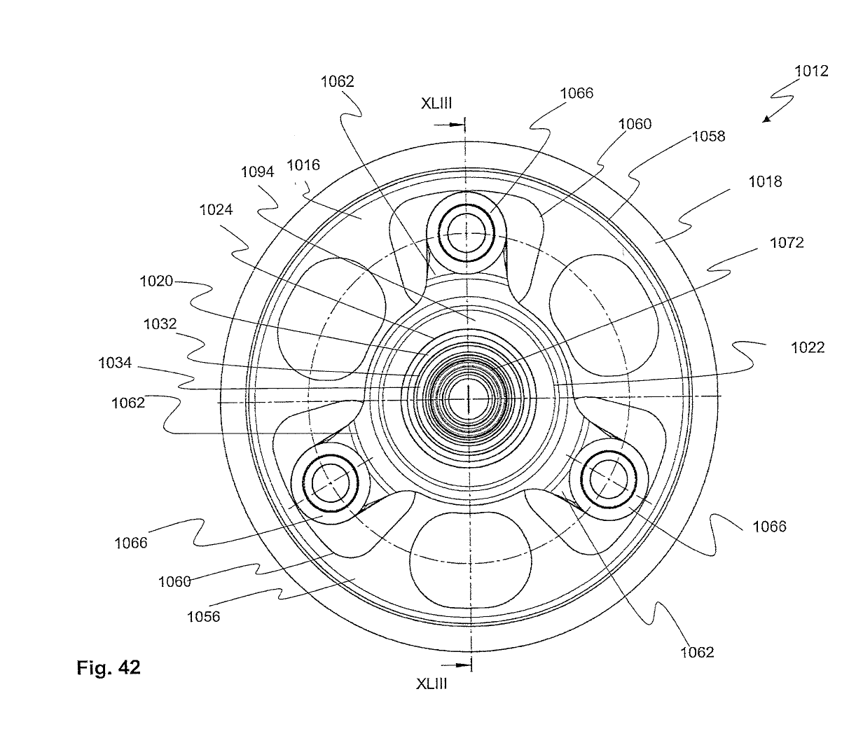

FIG. 42 a top view of the torsional vibration damper according to the eleventh specific embodiment;

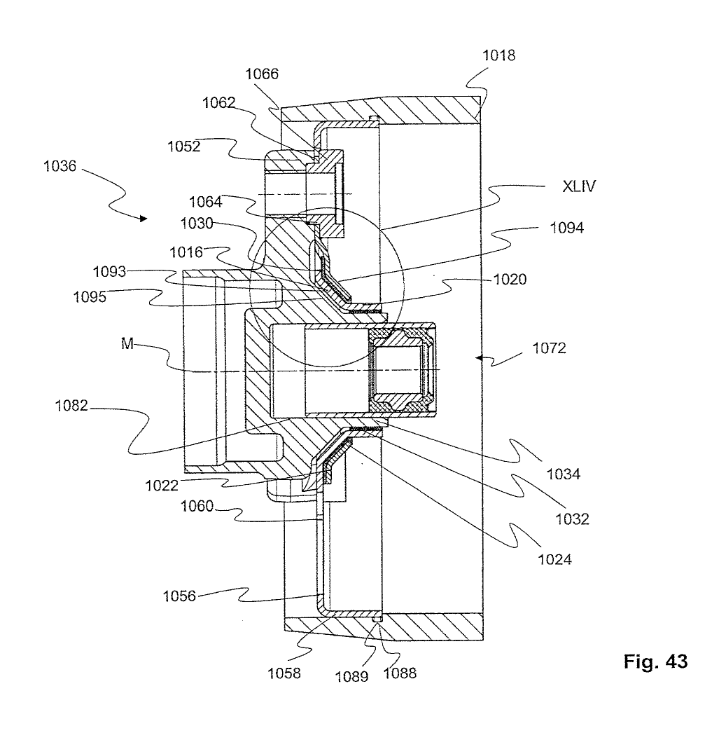

FIG. 43 a sectional view along sectional line XLIII-XLIII in FIG. 42;

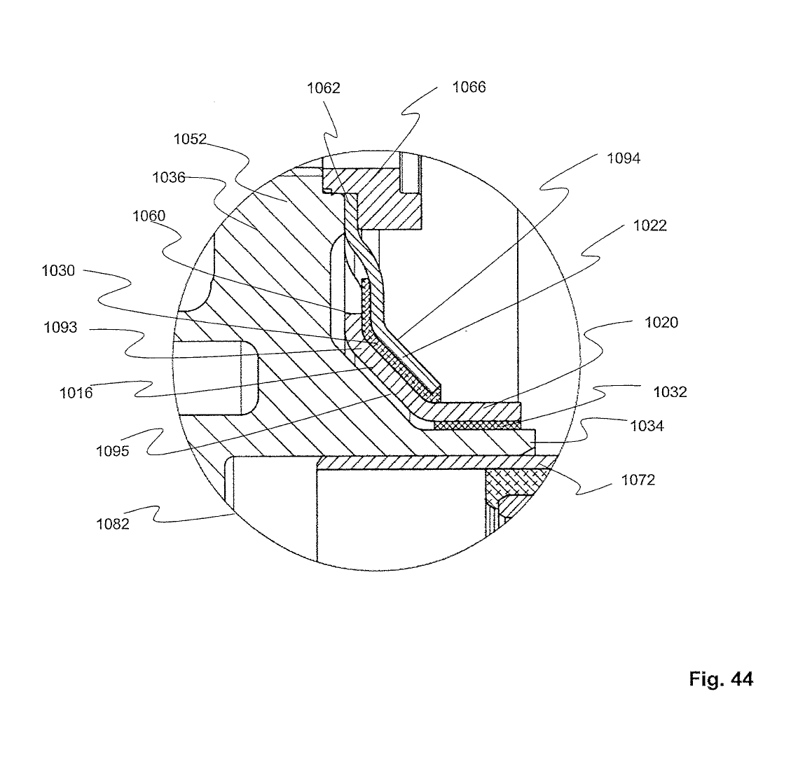

FIG. 44 a detailed view of the detail XLIV in FIG. 42;

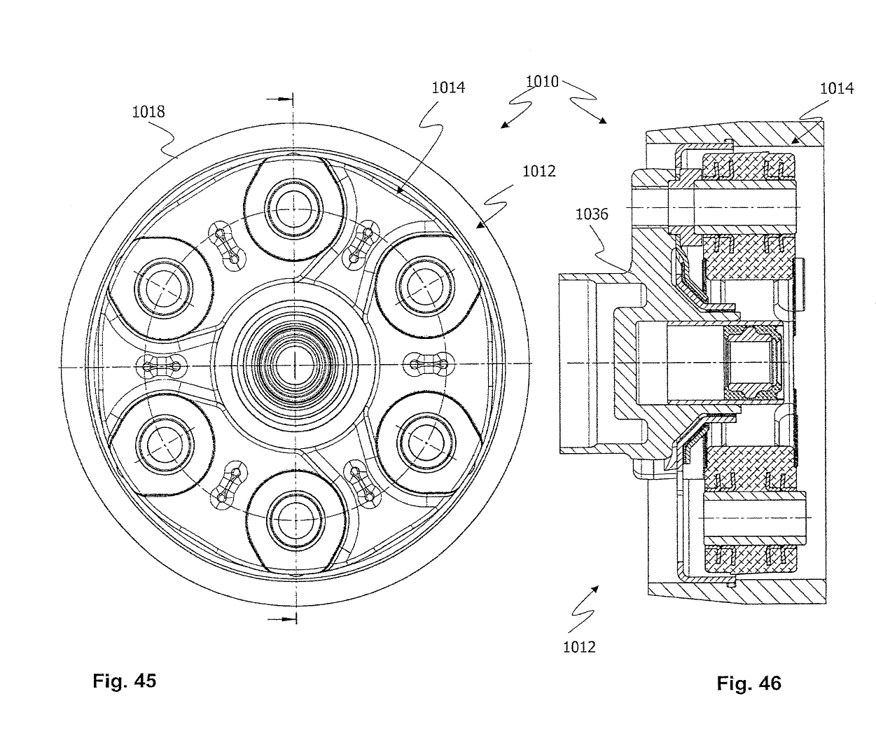

FIGS. 45 and 46 views of torque transmitting device according to the eleventh specific embodiment;

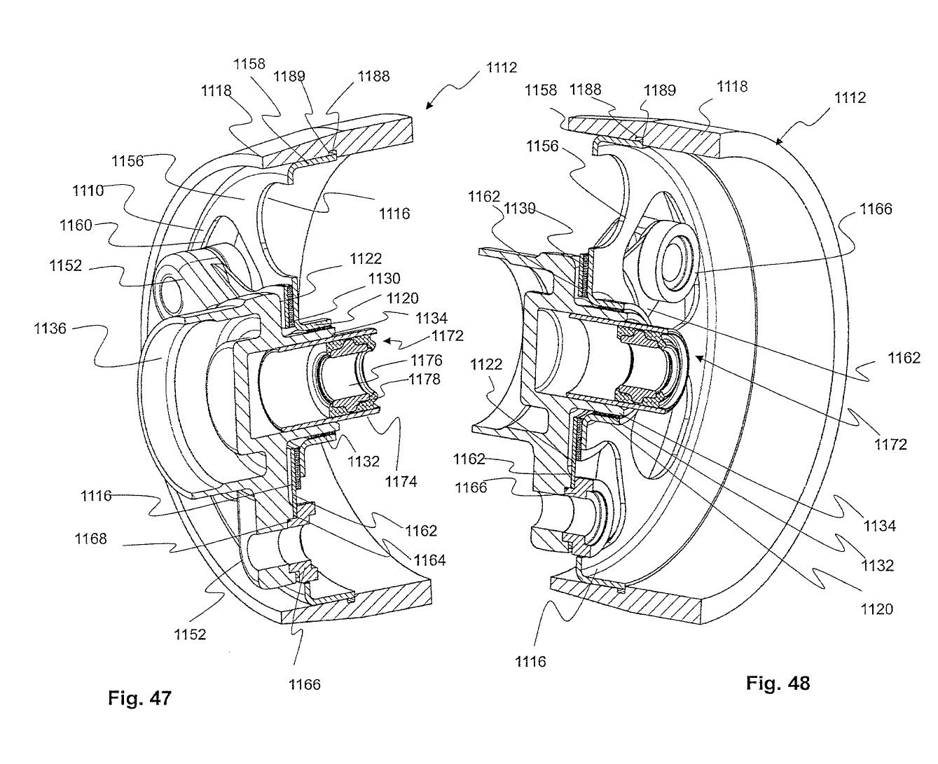

FIGS. 47 and 48 perspective sectional views of a torsional vibration damper according to a twelfth embodiment;

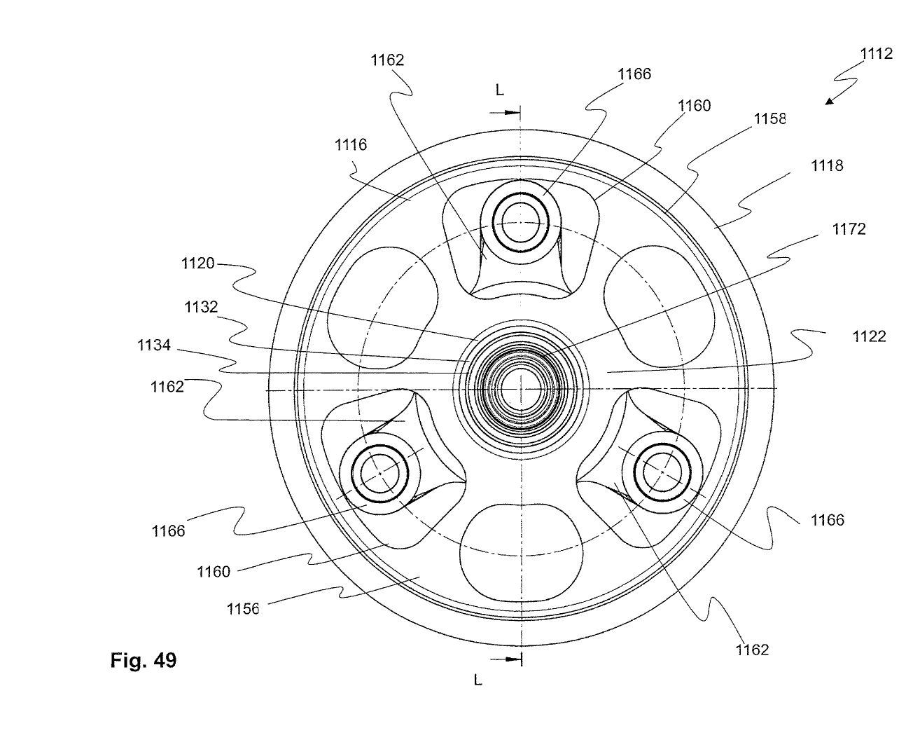

FIG. 49 a top view of a torque transmitting device according to a twelfth specific embodiment;

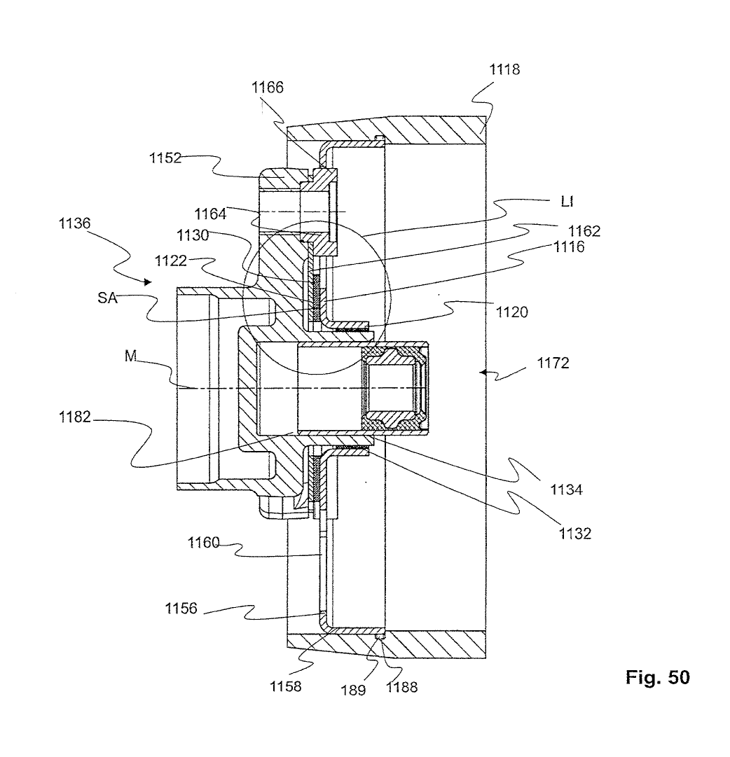

FIG. 50 a sectional view along sectional line L-L in FIG. 49;

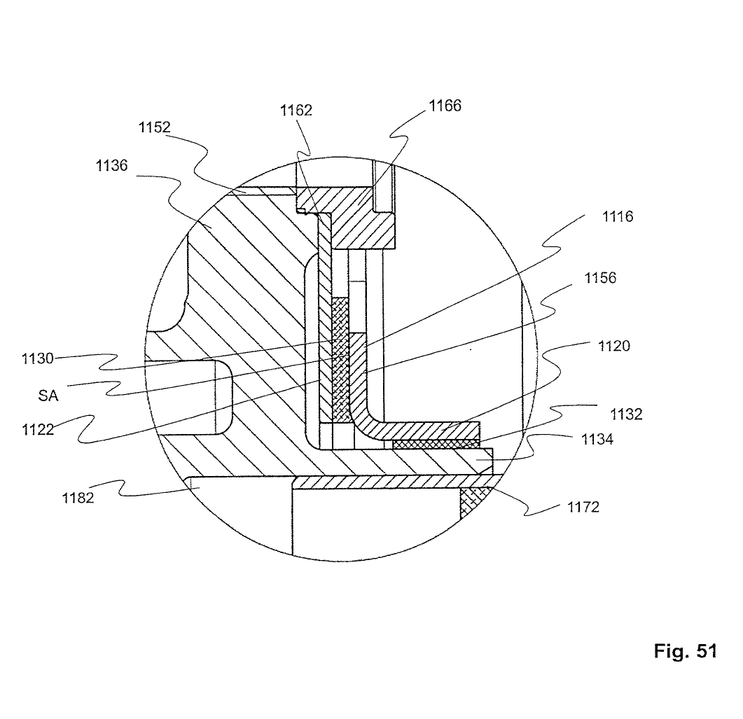

FIG. 51 a detailed view of the detail LI in FIG. 49;

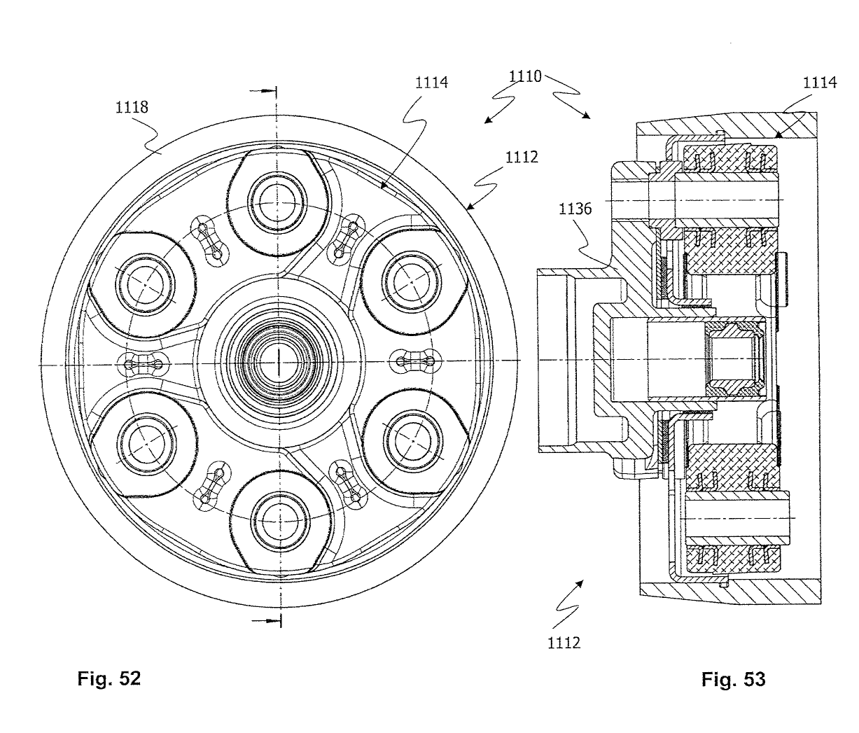

FIGS. 52 and 53 views of torque transmitting device according to the twelfth specific embodiment;

FIG. 1 shows a perspective view of a torque transmitting device according to a first specific embodiment of the invention. The torque transmitting device is labeled as 10 in general.

The torque transmitting device 10 comprises a torsion vibration damper 12 and an elastic articulated body 14, embodied here in the form of an articulated disk. The torsional vibration damper 12 comprises a ring-shaped first part 16 on which the flywheel mass 18 and a bearing section 20 are arranged and a second part 22. A in receiving section 24, which receives the bearing section 20 of the first part 16, is recognizable only in sections of the second part 22 of the torsional vibration damper 12. The receiving section 24 has radial pocket-shaped recesses 26, which engage in the corresponding radial protrusions 28 of the bearing section 20 of the first part 16 with a play. Elastic elements 30, which are under a compressive load during operation of the torque transmitting device, are provided between corresponding recesses 26 and protrusions 28. A bearing element 32 in the form of a friction bearing bush can be discerned in the bearing section 20 of the first part 16 of the torsional vibration damper 12. Furthermore, a section 34 of a flange 36 that serves as a bearing means is also discernible. The friction bearing 32 is situated between the bearing section 20 and the section 34 of the flange 36 that serves as the bearing means.

The elastic articulated body 14 has a known design that has been manufactured in large numbers by the patent applicant for quite a while. It includes an elastic sheathing 38, which accommodates six bushes 40. One or more thread packages (not shown) extend in an essentially known manner between two bushes 40 and are also embedded in the rubber elastic sheathing 38.

FIG. 2 shows a top view of the torque transmitting device 10.

The torsional vibration damper 12 and the elastic articulated body 14 can also be seen in FIG. 2.

The bearing section 20 has inner sections 42 extending radially in the circumferential direction in addition to the protrusions 28. Like the bearing section 20 of the first part 16, the receiving section 24 of the second part 22 has sections 44 and 46 extending in the circumferential direction. The sections 44 and 46 extending in the circumferential direction are each connected by a wall 48 extending essentially in the radial direction. The protrusions 28 of the bearing section 20 have side faces 50 which are connected to the walls 48 of the receiving section 24 by the elastic elements 30. A radial recess 28 of the receiving section 24 is formed by two walls 48 and a section 46 extending in the circumferential direction. The sections 42 of the bearing section 24 extending in the circumferential direction are in contact with the friction bush 32 which is in turn in contact with the section 34 of the flange 36 that serves as the bearing means.

In the case of a torsional vibration damping relative movement between the first part 16 and the second part 22 of the torsional vibration damper 12, the protrusions 28 move in the direction of a wall 48 of the recesses 26 in the receiving section 24 due to inertia so that the elastic elements 30 are under a compressive load. The compression load is definitely more advantageous than other loads such as tensile or shearing loads with respect to the lifetime of the elastic elements 30. The bearing section 20 moves on the section 34 of the flange 36 serving as the bearing means. In other words, the sections 42 of the bearing section 20 slide over the friction bearing bush 32 on the section 34 of the flange 36. At high loads, the protrusions 28 and recesses 26 act as stops with the mediation of the elastic elements 30.

FIG. 3 shows a sectional view along the sectional line II-II in FIG. 2.

FIG. 3 shows the flange 36. In addition to the tubular section 34 which serves as the bearing means, the flange 36 comprises three arms 52 which serve to provide a rotationally fixed connection to the second part 22 of the torsional vibration damper 12 and the elastic articulated body 14. Of the three arms 52 of the flange 36, only two can be seen in FIG. 3. The flange 36 also comprises a connecting section 54 which serves to connect to a shaft section (not shown) of a shaft arrangement and/or of an automotive drive train.

The first part 16 of the torsional vibration damper 12 has a section 56 extending at a right angle to the central axis M of the torque transmitting device 10. The section 56 connects the bearing section 20 to another section 58 running parallel to the central axis M with the flywheel mass 18 mounted thereon. Furthermore, openings 60 which allow a connection of the arms 52 of the flange 36 to the second part 22 and also to the articulated body 14 are formed in the section 56 of the first part 16. The second part 22 has sections 62, which extend in the radial direction and protrude into the openings 60 in at least some sections and are even provided with openings 64. The openings 64 in the sections 62 of the second part 22 receive intermediate elements 66 which serve to connect the flange 36 to the second part 22 and by way of the bushes 40 of the articulated body 14 serve to form a connection to the articulated body 14. The intermediate elements 66 are designed in steps and are in contact with a second part 22 along a section extending radially and are thus accommodated with a tubular section in a recess 68 on the arm 52 of the flange 36. The intermediate element 66 also has another recess, in which the bushes 40 are accommodated in some sections. Since both the arm 52 of the flange 6 and the intermediate element 66 and the bushes 40 each have an opening, a connecting channel 70 extends through the arm 52, the intermediate element 66 and the bushes 40. The second part 22 of the torsional vibration damper 12, the articulated body 14 and the flange 36 can be interconnected by the connecting channel 70, in particular being bolted together by means of suitable bolts (not shown).

The articulate body 14 is arranged between the receiving section 24 of the second part 22 and the section 58 of the first part 16 extending in the axial direction. The articulated body 14 like the second part 22 is also accommodated in the first part 16 of the torsional vibration damper 12. The second part 22 extends radially around the bearing section 20 of the first part 16.

For example, if the flange 36 is driven with a torque, then the torque is transferred from the flange 36 to the second part 22 of the torsional vibration damper 12 and to the elastic articulated body 14. The flywheel mass 18 and/or the first part 16 begin(s) to move with a delay due to the mass moment of inertia of the flywheel mass 18. The size of this delay and/or the amplitude of the flywheel mass 18 is/are determined to a significant extent by the rubber elastic elements 30 and/or their stiffness and their damping. After this delay, the first part 16 with the flywheel mass 18 having the bearing section 20 begins to move on the section 34 of the flange 36, i.e., the bearing section 20 slides over the friction bushing 32 on the section 34 of the flange 36. The torsional vibration damper 12 is very stiff in the radial direction due to the radial bearing support of the first part 16 with the bearing section 20 on the tubular section 34 of the flange 36.

The openings 60 in the section 56 of the first part 16 extending radially are dimensioned in accordance with the maximum allowed amplitude and/or the maximum allowed relative angle between the first part 16 and the second part 22.

A predetermined radial gap s can be seen between the elastic articulated body 14 and the section 58 of the first part 16 extending around the articulated body 14 in the circumferential direction. This gap is not uniform over the circumference of the articulated body 14. The dimension s denotes the maximum gap in the resting state and one of the locations along the circumference of the articulated body 14, where the bulging in the articulated body is the greatest during operation under load. The predetermined gap s may be of such dimensions that the elastic articulated body 14 is in contact with the section 58 of the first part 16 extending around the articulated body 14 during operation of the torque transmitting device 10 after a predetermined rotational speed and/or a predetermined torque has been exceeded.

In an alternative embodiment (not shown), the first part 16 is made of plastic or a material having comparable sliding properties and is supported directly with its bearing section 20 as a friction body on the tubular section 34.

Additional specific embodiments of the invention are described below. The same reference numerals are used for similar components and features or those having the same effect, but an additional digit is added in front.

FIG. 4 shows a perspective view of a torque transmitting device 110 according to a second specific embodiment of the Invention.

The second specific embodiment shown in FIG. 4 corresponds largely to the first specific embodiment described in FIGS. 1 to 3 but a centering sleeve 172 is accommodated in the tubular section 134 of the flange 136. The bearing section 120 of the first part 116 of the torsional vibration damper 112 is movably supported by the friction bushing 132 on the section 134 of the flange 136, which serves as the bearing means. A centering sleeve 172, which serves to center a shaft journal (not shown) of a shaft section of a shaft arrangement, is provided in the tubular section 134 of the flange 136.

FIG. 5 shows a top view of the torque transmitting device 110, in which the centering sleeve 172 can be seen.

FIG. 6 shows a sectional view of the torque transmitting device 110 along the sectional line V-V in FIG. 5.

FIG. 6 shows the centering sleeve 172, which is accommodated in the tubular section 134 of the flange 136. The centering sleeve 172 has an outer bush 174 and an inner bush 176. The outer bush 174 and the inner bush 176 are connected to one another by means of an elastic layer 178. The elastic layer 178 spans the outer circumferential surface of the inner bush 176 and the inner circumferential surface of the outer bush 174 essentially completely. The inner bush 176 may be made of a plastic and serves to receive a shaft journal of a shaft section (not shown) which is connected to another shaft section (not shown) by means of the torque transmitting device 110. Furthermore, the elastic layer has a sealing lip 180 which can come into contact with the shaft journal (not shown).

The centering sleeve 172 is accommodated in an opening 182 in the tubular section 134 of the flange 136. The opening 182 according to this embodiment is a blind opening.

FIG. 7 shows a perspective view of a torque transmitting device 210 according to a third specific embodiment of the invention.

According to a third specific embodiment of the invention, the bearing section 220 of the first part 216 and the receiving section 224 of the second part 222 are designed to be tubular. The elastic element 230 extends between the bearing section 220 and the receiving section 224.

FIG. 8 shows a top view of the torque transmitting device 210, in which the sections 220 and 224 in the form of tubes can be seen. The elastic element 230 in the form of an elastomer layer that is vulcanized on one or both sides or pressed in, so that it is flush and fills the radial clearance between the bearing section 220 and the receiving section 224 extends between the bearing section 220 and the receiving section 224. Thus, according to this specific embodiment, a single elastic element 230 is provided, extending in the circumferential direction in the clearance.

FIG. 9 shows a sectional view of the torque transmitting device 210 along the sectional line VIII-VIII in FIG. 8.

FIG. 9 shows the tubular bearing section 220 and the tubular receiving section 224 which are connected by means of the elastic element 230. The elastic element 230 spans the inner circumferential surface of the tubular receiving section 224 and extends up to the radial section 262 of the second part 222. The elastic element 230 also covers some sections of the radial section. The elastic element 230 thus recognizably extends between the radial section 256 of the first part 216 and the radial section 262 of the second part 222.

FIG. 10 shows a perspective view of a torque transmitting device 310 according to a fourth specific embodiment of the invention.

The fourth specific embodiment of the invention corresponds largely to the embodiment shown in FIGS. 7 to 9 wherein a centering sleeve 372 is again accommodated in the section 334 of the flange 336.

FIG. 11 shows a top view of the torque transmitting device 310 and also shows the centering sleeve 372.

FIG. 12 shows a sectional view along the sectional line XI-XI in FIG. 11.

It can be seen in FIG. 12 that the opening 380 in the flange 336 according to this embodiment is a through-opening. The centering sleeve 372 completely takes up the opening 380 in the axial direction of the central axis M. The centering sleeve 372 has an outer bush 374 and an inner bush 376 which are connected to one another by means of an elastic layer 378. The elastic layer 378 extends completely along the inside circumferential surface of the outer bush 374.

FIG. 13 shows a perspective view of a torque transmitting device 410 according to a fifth embodiment of the invention.

In FIG. 13, the tubular bearing section 420 and the tubular receiving section 424 can be seen, with the elastic element 430 extending between them. The friction bearing 432 can be discerned in the tubular bearing section 420 of the first part 416. FIG. 14 shows a top view of the torque transmitting device 410 in which the friction bearing 432 can be seen on the inside circumferential surface of the tubular bearing section 420 of the first part 416. In comparison with the embodiments described above, the friction bearing according to the fifth embodiment is designed to be stronger in the radial direction.

FIG. 15 shows a sectional view of the torque transmitting device 410 along the sectional line XIV-XIV in FIG. 14.

FIG. 15 shows the first part 416 and the second part 422 of the torsional vibration damper 412. The tubular bearing section 420 of the first part 416 and the tubular receiving section 424 of the second part 422 are connected to one another by means of the elastic element 430. The friction bearing 432 can be seen in the tubular bearing section 420. The bush-shaped friction bearing 432 extends from the right end of the tubular bearing section 420 in the direction of axis M into the bearing section 420 and takes up somewhat more than half of the axial extent of the tubular bearing section 420. In this embodiment, the flange 436 again has a section 434 that serves as a bearing means but has a greatly shortened design in comparison with the first embodiment, for example, as shown in FIGS. 1 to 3. The front end of the section 434 of the flange 436 is contact with the bearing bush 432 and/or with one of its end faces. The bearing bush 434 is in contact along its outer circumferential surface with the inside circumferential surface of the tubular bearing section 420. A small radial distance is discernible between the outer circumferential surface of the tubular section 434 of the flange 436 and the inner circumferential surface of the tubular bearing section 420.

FIG. 16 shows a perspective view of a torque transmitting device 510 according to a sixth embodiment of the invention. The sixth embodiment of the invention corresponds largely to the fifth embodiment of the invention, which is shown in FIGS. 13 to 15, wherein a centering sleeve 572 can be seen within the friction bearing 532 and within the section 534 of the flange 536 (FIG. 18).

FIG. 17 shows a top view of the torque transmitting device 510, in which the centering sleeve 572 is in contact with the inside circumferential surface of the friction bearing 532.

The bearing section 520 of the first part 516 and the receiving section 524 of the second part 522 also have a tubular shape in the fifth embodiment of the invention.

FIG. 18 shows a sectional view of the torque transmitting device 510 along the sectional line XVII-XVII in FIG. 17.

FIG. 18 shows the centering sleeve 572, which extends along the inside circumferential surface of the friction bearing and/or the bearing bush 532 and the inside circumferential surface of the tubular section 534 and/or the opening 580 in the flange 536. The tubular bearing section 520, which also serves as a bearing means assigned to the flange, is thus supported radially on the tubular section 534, which serves as a bearing means, and on the centering sleeve 572 by means of the friction bearing 532.

FIG. 19 shows a perspective view of a torque transmitting device 610 according to a seventh embodiment of the invention.

The design of the torque transmitting device 610 corresponds largely to the design of the torque transmitting device 10 according to the first embodiment, in which the flange 636 (not shown in FIG. 19) has a different design.

FIG. 20 shows a top view of the torque transmitting device 610 with the elastic articulated body 614 and the torsional vibration damper 612 comprising a first part 616 and a second part 622.

FIG. 21 shows a sectional view along the sectional line XX-XX in FIG. 20.

It can now be seen in FIG. 21 that the flange 636 according to this embodiment does not have a tubular section but instead serves only to connect the second part 622 of the torsional vibration damper 612 and the articulated body 614.

Furthermore, FIG. 21 shows the opening 680 in the flange 636, which can serve to receive a centering sleeve (not shown), for example. The friction bearing 632 is shown on the inner circumferential surface of the bearing section 620.

FIG. 22 shows a perspective view of a torque transmitting device 710 according to an eighth embodiment of the invention, which corresponds largely to the embodiment shown in FIGS. 19 to 21. The centering sleeve 772, which serves as a bearing means assigned to the flange 736, can be seen in the bearing section 720 of the first part 716 of the torsional vibration damper 712. The bearing section 720 is supported on the centering sleeve 772 by means of the friction bearing 732.

FIG. 23 shows a top view of the torque transmitting device 710, in which the centering sleeve 772 in the bearing section 720 and the friction bearing 732 can be seen between the bearing section 720 and the centering sleeve 772.

FIG. 24 shows a sectional view along the sectional line XXIII-XXIII in FIG. 23.

The flange 736 has the opening 780, in which the centering sleeve 772 is accommodated in at least some sections. The centering sleeves 772 is a bearing means assigned to the flange 736. The bearing section 720 is supported by means of the friction bearing 732 and/or the bearing bush 732 on the centering sleeve 772. The bearing section 720 can thus execute a relative movement on the centering sleeve 772 by means of the friction bearing 732.

FIG. 25 shows a top view of the first part 16 and the second part 22 of the torsional vibration damper 12. The first part 16 and the second part 22 according to this exemplary embodiment are provided with corresponding profilings. Protrusions 80 each being offset by 120° relative to the others around the central axis M are provided on the second part 22. The protrusions 80 on the second part 22 are accommodated between protrusions 82 on the first part 16, thus establishing a maximum relative angle between the first part 16 and the second part 22. As soon as the protrusions 80 on the second part 22 are in contact with one of the protrusions 82 of the first part 16, no further relative rotation is possible between the first part 16 and the second part 22.

The openings 60 in the radial section 56 of the first part 16 can also be seen in FIG. 25. The radial arms 62 of the second part 22 protrude into openings 60 and/or overlap partially with the openings 60 to permit a connection of the arms 62 of the second part 22 with the flange (not shown) and the articulated body (not shown). Openings 64 in which intermediate elements (not shown) can be accommodated can be seen in the arms 62.

FIG. 26 shows a detailed view of the detail X in FIG. 25. FIG. 26 shows the protrusion 80 on the second part 22 and the protrusions 82 on the first part 16. The protrusion 80 on the second part 22 extends between the protrusions 82 on the first part, so that the protrusion 80 comes to a stop at a predetermined relative angle against one of the protrusions 82 of the first part to limit the amplitude of the first part 16.

The protrusions 80, 82 may be designed in the form of beads when the parts 16, 22 are made of one sheet of metal.

FIG. 27 shows a sectional view along the sectional line XXVI-XXVI in FIG. 26 in which the protrusions 80, 82 are discernible. The protrusion 80 on the second part 22 is coated here with an elastomer layer 84. However, it is conceivable for the protrusions 82 on the first part 16 to be coated with an elastic layer or for the protrusions 82 and the protrusions 80 to be coated with an elastic layer.

FIG. 28 shows a top view of a torque transmitting device 810 according to a ninth embodiment of the invention.

The elastic articulated body 814 according to this embodiment has a polygonal shape. Unlike the embodiments described above having an essentially round elastic articulated body, the elastic articulated body 814 according to this embodiment is designed as a polygon. The radial distance between the circumferential surfaces of the articulated body 814 and the interior circumference of the first part 816 varies accordingly in the circumferential direction. This makes it possible to effectively prevent the articulated body 814 from coming to a stop against the first part 816 and/or the flywheel mass 818 of the torsional vibration damper 812.

FIG. 28 also shows a sealing lip 884 which extends in the radial direction up to the centering sleeve 872.

FIG. 29 shows a sectional view along the sectional line XXIX-XXIX in FIG. 28.

The elastic articulated body 814 has string packages 885 and collar elements 886 which serve to secure the string packages 885 on the bushes 840. The flywheel mass 818 has a shoulder on its inside circumferential surface, with which the end face 887 of the section 858 of the first part 816, which extends in the axial direction, is in contact.

A sealing element and/or a sealing lip 884 is/are formed on the elastic element 830. The sealing lip 884 spans the at least one bearing element 832 and the end face of the section 834 of the flange 836 and is in contact with the end face of the outer bush 874 of the centering sleeve 872. The sealing lip 884 runs in a curve in the radial direction from the elastic element 830 to the end face of the outer bush 874 of the centering sleeve 872.

FIG. 30 shows an enlarged view of the detail XXX in FIG. 29.

FIG. 30 shows the sealing lip 884 clearly. The sealing lip 884 is designed in one piece with the elastic element 830 and extends from the elastic element 830 to the end face of the outer bush 874. The sealing lip 884 spans the bearing element and/or the friction bushing 832 as well as the flange section 834 and is then in contact with the outer bush 874. The sealing lip 884 prevents dirt from being able to penetrate between the individual components and Impair the function of the vibration damper 812. This is to be taken into account in the area of the friction bushing 832 in particular, because dirt penetrating there can have a negative effect on the sliding of the bearing section 820 over the friction bushing 832 on the section 834 of the flange 836.

FIG. 31 shows a top view of a torque transmitting device 910 according to a tenth embodiment of the invention.

FIG. 32 shows a sectional view along the sectional line XXXII-XXXII in FIG. 31.

The first part 916 and/or the section 958 of the first part 916 according to this embodiment has/have an end 988, which is curved outward in the radial direction. The end 988 with an outward curve is accommodated in a groove 989 in the flywheel mass 918. The flywheel mass 918 and the first part 916 can thus be additionally secured by a form-fitting connection to one another.

Between the friction bushing 932 and the bearing section 920 an elastic layer 990 is provided, connecting the bearing section 920 to the friction bush 932. The elastic layer 990 has a sealing lip 984 which extends inward in the radial direction. The first part 916 according to this embodiment is constructed in two modular units which are connected to one another at the joint FS. A modular unit is formed by the bearing section 920, the elastic element 930, the friction bush 932 and the elastic layer 990. The second modular unit is formed by the radial section 956 and the section 958 extending in the axial direction.

FIG. 33 shows a detailed view of the detail XXXIII in FIG. 32.

FIG. 33 shows the sealing lip 984 which spans the friction bush 932 and is contact with the section 934 of the flange 936. The sealing lip 984 is provided on the elastic layer 990 which connects the bearing section 920 to the friction bush 932. The friction bush 932 has recesses 991 which hold the dirt that penetrates between the friction bush 932 and the section 934 of the flange 936.

FIG. 34 shows a detailed view of the detail XXXI in FIG. 31.

FIG. 34 shows the recesses 991 in the friction bush 932 which extend in the axial direction through the friction bush 932. The elastic layer 990, which connects the friction bush 932 to the bearing section 920, extends between the friction bush 991 and the bearing section 920.

FIGS. 35a to 35c show views of the friction bush 932 with the recesses 991 which extend in the axial direction on the inside circumferential surface of the friction bush 932 and each takes up a predetermined section of the inside circumferential surface of the friction bush 932.

FIG. 36 shows a perspective view of the first part 916 in the separated condition of the two modules M₁ and M₂. The module M₁ is formed by the bearing section 920, the elastic element 930 and the friction bush 932. The elastic element 930 is formed by a plurality of protrusions extending in the radial direction and by a layer connecting these protrusions. This is also true of the embodiment described previously. The friction bush 932 is connected to the inside circumference of the bearing section 920 by means of the elastic layer (not shown in FIG. 36). The module M₁ has a joining surface FF₁ which is formed by an end face of the bearing section 920.

The module M₂ is formed by the section 956 extending in the radial direction and the section 958 of the first part 916 extending in the axial direction. The end section 988 which is bent outward radially can be seen on the section 958. The section 956 extending in the radial direction has an opening 992, around which the joined surface FF₂ extends radially.

The first module M₁ and the second module M₂ can be connected to one another at the joining surfaces FF₁ and FF₂. The connection between the modules M₁ and M₂ can be established, for example, by welding.

FIG. 37 shows a perspective view of the first part 916 with the modules M₁ and M₂ in the joined state.

The two modules M₁ and M₂ were joined together at their joining surfaces FF₁ and FF₂ (see FIG. 36) wherein the joining surfaces FF₁ and FF₂ form the joint FS.

FIG. 38 shows a top view of the first part 916 in the connected state of the two modules M₁ and M₂.

FIG. 39 shows a sectional view along the sectional line XXXIX-XXXIX in FIG. 38.

It can be seen in FIG. 39 that the first module M₁ is formed by the bearing section 920, the elastic element 930, the friction bush 932 and the elastic layer 990. The elastic layer 990 connects the friction bush 932 to the bearing section 920 and has a sealing lip 984 extending radially inward. The second module M₂ is in turn formed by the sections 956 and 958. The two modules M₁, M₂ are joined at their respective joining surfaces FF₁ and FF₂, thereby forming the joint FS.

The individual components of the module M₁ are joined by vulcanization. Therefore, successive steps such as pressing the friction bush 932 in place can be omitted.

FIGS. 40 and 41 show perspective sectional views of a torsional vibration damper 1012 according to an eleventh embodiment of the invention.

The torsional vibration damper 1012 comprises an annular first part 1016 on which the flywheel mass 1018 and the bearing section 1020 are arranged and a second part 1022. The first part 1016 and the second part 1022 are connected to one another by an elastic element 1030. The second part 1022 comprises a receiving section 1024 through which the bearing section 1020 of the first part 1016 extends. A friction bearing bush 1032 is provided in the bearing section 1020 of the first part 1016 of the torsional vibration damper 1012. The friction bearing bush 1032 is arranged between the bearing section 1020 and a section 1034 of a flange 1036, which serves as a bearing means. The first part 1016 has a section 1056 extending in the radial direction and connected to a section 1058 extending in the axial direction. The flywheel mass 1018 is provided on the section 1058. An obliquely running section of the first part 1016 extends between the section 1056 extending in the radial direction and the tubular bearing section 1020. Openings 1060, which allow a connection of the arms 1052 of the flange 1036 to the second part 1022, are formed in the section 1056 of the first part 1016. The second part 1022 has sections 1062 extending in the radial direction, protruding into the openings 1060 in at least some sections and themselves being provided with openings 1064. The openings 1064 receive intermediate elements 1066, which serve to connect the flange to the second part 1022.

The elastic element 1030 extends between an obliquely running section 1093 of the first part 1016 and oblique section 1094 of the second part 1022, among others. A centering sleeve 1072 is accommodated in the tubular section 1034 of the flange 1036.

FIG. 42 shows a top view of the torsional vibration damper 1012, in which the first part 1016, the second part 1022 and the centering sleeve 1072 can be seen. The second part 1022 has three sections 1062, which extend in the radial direction, each having intermediate elements 1066 on their radial ends. The radial sections 1062 of the second part 1022 protrude into the openings 1060 in the section 1056 of the first part 1016 extending in the radial direction.

FIG. 42 shows the oblique section 1094 of the second part 1022 extending between the receiving section and/or the receiving opening 1024 and the sections 1062 extending in the radial direction.

FIG. 43 shows a sectional view along the sectional line XLIII-XLIII in FIG. 42.

The first part 1016 has the section 1093 running obliquely and at an angle to the central axis M between the bearing section 1020 and the section 1056 extending in the radial direction. Similarly, the second part 1022 has a section 1094, which extends obliquely and/or at an angle to the central axis M and is provided between the receiving section 1024 and/or the receiving opening 1024 and the sections 1062 extending in the radial direction. The elastic element 1030, which extends between the obliquely running sections 1093 and 1094 and, in at least some portions, between the sections 1056 and 1062 of the first part 1016 and of the second part 1022 extending in the radical direction, is arranged between the first part 1016 and the second part 1022.

The flange 1036 also has an oblique surface 1095, which is adapted in its inclination to the inclination of the oblique sections 1093 and 1094 of the first part 1016 and of the second part 1022.

FIG. 44 shows a detailed view of the detail XLIV in FIG. 43.

FIG. 44 shows the obliquely running sections 1093 of the first part 1016 and 1094 of the second part 1022 between which the elastic element 1030 extends. The elastic element 1030 extends outward in the radial direction along the sections 1062 extending in the radial direction of the second part 1022, i.e., it protrudes into the openings 1066 in the first part 1016.

FIGS. 45 and 46 show views of a torque transmitting device 1010 with the torsional vibration damper 1012 according to FIGS. 40 to 44 and an articulated body 1014 which may be designed according to the articulated bodies in FIGS. 24, 29 and 32.

FIGS. 47 and 48 show perspective sectional views of a torsional vibration damper 1112 according to a twelfth embodiment of the invention.

According to this embodiment, the second part 1122 is completely between the flange 1036 and the first part 1116. The second part 1122 has sections 1162 extending in the radial direction. Similarly the first part 1116 has sections 1158 extending in the radial direction. The elastic element 1130, which extends in the radial direction, is provided between sections 1158 and 1162, which also extend in the radial direction. The bearing section 1120 is supported on the flange section 1134 by means of a friction bearing bush 1132.

FIG. 49 shows a top view of the torsional vibration damper 1112 according to the twelfth embodiment.

It can be seen clearly in FIG. 49 that the second part 1122 is arranged behind the first part 1116 and/or on the back side of the first part 1116. The sections 1162 of the second part 1122 extending in the radial direction protrude into the openings 1160 in the radial section 1156 of the first part 1116. The intermediate elements 1166 are provided on the radial sections 1162 of the second part 1116.

FIG. 50 shows a sectional view along the sectional line L-L in FIG. 49.

The second part 1122 is provided between the flange 1136 and the first part 1116 in the axial direction of the central axis M. The following arrangement is obtained from left to right accordingly in the axial direction: flange 1136, second part 1122, elastic element 1130 and first part 1116. The spring element 1130 is provided between the sectional 1162 of the second part 1122 extending in the radial direction and the section 1156 of the first part 1116 extending in the radial direction. According to this embodiment, the second part 1122 is arranged on the side SA of the first part 1116 facing away from the bearing section 1120.

FIG. 51 shows a detailed view of the detail LI in FIG. 50.

The radial section 1162 of the second part 1122 and the radical section 1156 of the first part 1116 extend parallel to one another in the radial direction. The elastic element 1130 is provided between the two radial sections 1156 and 1162.

FIGS. 52 and 53 show views of a torque transmitting device 1110 with a torsional vibration damper 1112 according to FIGS. 47 to 51 and an elastic articulated body 1114. The elastic articulated body 1114 may be of the type illustrated in FIGS. 24, 29 and 32.

In all embodiments, the flywheel mass 18 of the torsional vibration damper 12 is not supported radially by the elastic elements—unlike the prior art—but instead is supported radially by means of the bearing section 20 directly on a bearing means assigned to the flange, i.e., a tubular section 34 of the flange 36 or a centering sleeve 72. The torsional vibration damper according to the invention therefore has a radial stiffness and is far less susceptible to imbalance in the drive train than is the case in the prior art.

1-27. (canceled)

28. A torsional vibration damper for damping vibrations of a shaft arrangement of an automotive drive train, comprising:
at least one first part comprising a flywheel mass,
at least one second part designed to be coaxial to the first part and designed for fastening the torsional vibration damper on a flange wherein the first part and the second part are connected by means of at least one elastic element, and
wherein the first part is provided with at least one bearing section which is designed for radial bearing support of the first part comprising the flywheel mass on a bearing means assigned to the flange, wherein the at least one elastic element is provided on a radial outer surface of the at least one bearing section.

29. The torsional vibration damper according to claim 28, wherein the bearing section of the first part is designed so that the bearing section slides between the first part and the second part on the bearing means assigned to the flange when there is a relative movement.

30. The torsional vibration damper according to claim 28, wherein the bearing section comprises at least one bearing element in particular a friction bearing which is arranged on a radial inside surface of the bearing section.

31. The torsional vibration damper according to claim 28, wherein the second part has at least one receiving section which receives the at least one bearing section of the first part in at least some segments, wherein the receiving section and the bearing section are connected by means of the least one elastic element.

32. The torsional vibration damper according to claim 31, wherein the bearing section of the first part and the receiving section of the second part are designed to be tubular.

33. The torsional vibration damper according to claim 31, wherein the bearing section has at least one protrusion which engages in at least one corresponding setback on the receiving section wherein the at least one elastic element is arranged between the at least one protrusion and the at least one setback.

34. The torsional vibration damper according to claim 28, wherein the first part and the second part have corresponding profilings which serve to adjust a maximum relative angle between the first part and the second part, wherein the profiling of the first part and/or of the second part is preferably coated with an elastic layer.

35. The torsional vibration damper according to claim 28, wherein the first part has at least one opening which allows a torque transmitting connection of the second part to a flange wherein the first part is designed so that a relative movement between the first part and the second part is possible.

36. The torsional vibration damper according to claim 28, wherein the first part is designed so that the flywheel mass extends at a predetermined radial distance around the bearing section.

37. The torsional vibration damper according to claim 30, wherein at least one sealing element is provided, at least spanning the at least one bearing element in the radial direction.

38. The torsional vibration damper according to claim 30, wherein the at least one bearing element has at least one recess on its inside circumferential surface.

39. The torsional vibration damper according to claim 28, wherein the first part is designed as a modular unit.

40. The torsional vibration damper according to claim 30, wherein the at least one bearing element is connected to the bearing section by means of at least one elastic layer.

41. The torsional vibration damper according to claim 28, wherein the first part and the second part are designed so that the at least one elastic element runs in at least some sections at an angle to the central axis.

42. The torsional vibration damper according to claim 28, wherein the first part has a section extending in the radial direction, and the second part has a section extending in the radial direction wherein the at least one elastic element extends between the radial sections of the first part and of the second part respectively.

43. The torsional vibration damper according to claim 28, wherein the second part is arranged on the side of the first part facing toward or away from the bearing section.

44. A torque transmitting device for transmitting torques between two shaft sections of a shaft arrangement of an automotive drive train comprising:
a torsional vibration damper according to claim 1, and
an elastic articulated body, and
wherein the elastic articulated body is connected to the second part of the torsional vibration damper and is arranged between the flywheel mass and the second part.

45. The torque transmitting device according to claim 44, wherein the torque transmitting device comprises a flange, which is connected to the second part of the torsional vibration damper and the elastic articulated body in a torque transmitting manner.

46. The torque transmitting device according to claim 45, wherein the flange is connected to the second part by means of at least one opening in the first part and is connected to the elastic articulated body in a torque transmitting manner.

47. The torque transmitting device according to claim 44, wherein the flange receives a centering sleeve in at least some sections.

48. The torque transmitting device according to claim 47, wherein the torsional vibration damper is supported radially on the centering sleeve by means of the bearing section of the first part.

49. The torque transmitting device according to claim 44, wherein the torsion vibration damper is supported radially on the flange by means of the bearing section of the first part.

50. The torque transmitting device according to claim 44, wherein a predetermined radial gap is provided between the elastic articulated body and a section of the first part extending around the articulated body.

51. The torque transmitting device according to claim 49, wherein the predetermined radial gap is of such dimensions that the elastic articulated body is in contact with the section of the first part extending around the articulated body during operation of the torque transmitting device after a predetermined rotational speed or a predetermined torque has been exceeded.

52. The torque transmitting device according to claim 50, wherein the at least one elastic articulated body has a polygonal shape wherein the predetermined radial gap changes in the circumferential direction.

53. A shaft arrangement in particular an automotive drive train having a torsional vibration damper according to claim 28.

54. A shaft arrangement in particular an automotive drive train having a torque transmitting device according to claim 44.
